(19) United States
(12) Patent Application Publication
(10) Pub. No.: US 2008/0224823 A1
(43) Pub. Date: Sep. 18, 2008

(54) Identification Systems

(75) Inventors: Marcus Maxwell Lawson, Hampshire (GB); Francis Kirkman Fox, Hampshire (GB)

Correspondence Address: BLAKELY SOKOLOFF TAYLOR & ZAFMAN LLP, 1279 OAKMEAD PARKWAY, SUNNYVALE, CA, 94085-4040, US

(73) Assignee: FIRST ONDEMAND LIMITED, LONDON (GB)

(21) Appl. No.: 11/817,073

(22) PCT Filed: Feb. 27, 2006
(86) PCT No.: PCT/GB06/00675

§ 371 Date: Nov. 28, 2007

(30) Foreign Application Priority Data
Feb. 25, 2005 (GB) 0503972.2

(51) Int. Cl. G06K 19/00

(52) U.S. Cl. 340/5.8

(57) ABSTRACT

An identification system where providing' identification data sets that contain different types of information accessible by different parties, removes the need for all potential readers of the object to be able to access all information, and to contact a third party during the verification process is disclosed. The identification data sets are encrypted and printed in a portable physical form as an identity object. Graphical symbols, such as a data matrix, or RFID tags or secure chips may be used to store encrypted data. These may be incorporated into a passport or other identification document. Additional identity objects may be printed for use in identifying objects connected with a user or source that contain a subset of the information in the original data matrix.

This invention relates to systems and apparatus for storing and distributing personal information or article information, and in particular for storing and distributing identification information.

The storage of identification information for both persons and articles has become of increasing importance in the light of national security issues and health and safety concerns. For example, the proposed introduction of identification cards has brought about concerns as to how an individual may be reliably identified, with the lowest likelihood that the identification may be faked or stolen. For articles such as luggage, travelling with an air passenger, it is necessary to identify and determine ownership of the luggage and track it to its final destination, as well identifying the passenger owning the luggage. Ideally, the passenger should be traceable continuously across a journey, which may entail several flights or trips with different carriers. In situations where the traceability of a product is of high importance, for example, in the food industry, it is necessary to identify and trace products throughout a production and supply process (end-to-end traceability).

In each of the situations outlined above, it is necessary to be able to trace the information relating to the person or article as quickly as possible. There are known tracing systems and methodologies, which are often proprietary, and which are used by manufacturers in the food industry. It is often possible to trace a product from supplier to retailer, but once the item has been scanned and sold, it is generally no longer traceable.

Where personal information is concerned, there are other issues. Identification is at present commonly done by a combination of visual and written data, for example, a passport or photo-ID card. The written data may be encrypted or randomised in some way, for example, by the allocation of a bar code or random identification number. Forgery of such identification documents, or the use of false or stolen identities causes great difficulties in tracing and identifying individuals. Although safeguards are built into documents to enable fake documentation to be identified, there is no method of easily ensuring that the identity of the owner of the document is correct.

One approach is to encrypt data used for personal identification in a barcode that contains public key encryption and digital signature information. Barcodes may also be used to store identity information in a secure manner, by using a barcode to replace identity text in a document such as a passport. GB2378292 discloses the use of a barcode on a passport to prevent fraud. Information regarding the holder's personal attributes or identification information is stored in a barcode. When the barcode is scanned, a remote database at the passport issuing authority matches the barcode with a stored photograph of the holder, and transmits the photograph along with the barcode protected identity information to the immigration officer or other authority scanning the passport barcode. Such a barcode system can also be used to verify identity for payment, and include bank or credit card details.

A second method of increasing the security of the identification document, and therefore reducing the likelihood of a forgery and increasing the likelihood that the individual is correctly identified, is to use biometric data. However, the use of biometric data is controversial, and its general inclusion in identification documents has not yet been found to be a practicable solution, which provides a sufficient level of confidentiality and security and reliable reading in different locations with different machine readers or reading parameters.

EP1349123 discusses the verification and authentication of an identity based on biometric information. This document discloses the use of trusted identity authorities (TIA's) and trusted privilege authorities (TPA's), for granting privileges to individuals such as driving licenses or travel documentation. In order to establish an identity, an individual must prove their identity to a TIA, including biometric information, and details that can be subsequently verified by the TIA using commercially available databases. When the identity vetting process has been completed, an identity certificate and the associated biometric data (such as a photograph or fingerprints) are stored in a central database at the TIA. The identity certificate is then encoded as a cryptographically secure certificate (such as an X.509 certificate) and reproduced as a machine-readable two-dimensional barcode. The barcode contains both a cryptographic hash of the identity data and an encrypted signature provided by the TIA.

To verify the identity of an individual, a TPA scans the barcode to retrieve the encoded information. The TPA holds a copy of the TIA database, and retrieves the associated biometric information and creates a hash of the identity certificate. The hash of the retrieved information and the information held in the barcode are compared to verify the identity of the holder. The biometric information is retrieved from the database in an uncompressed state, and directly compared with the individual.

Only agents of the TIA can use the system to verify the identity of an individual. All of the information on the identity certificate is encoded in the barcode, and additional information must be retrieved from a local or remote database before the identification verification can be completed. As all of the information pertaining to the individual is stored in and retrieved from the barcode, each agent must have the same level of access and security. As an additional security measure, the biometric information is compared with that stored in the database by the agent, but in the case of an image, for example, there is some discretion in deciding whether the identity of the individual has been successfully verified.

Each of the above methods relies on a single level of access by trusted parties to all information encoded in the barcode. In order to complete the identification of the individual, further information provided by a trusted party is required, such as a photograph or other biometric information.

Each of the methods described above relies on a single level of information security, where the information contained in the barcode is accessible to all parties who are able to read the barcode. Furthermore, in situations where an additional security measure is needed, an external authority is contacted for information not contained in the barcode to verify the identity of the individual concerned. Therefore, although identification information is encoded in the barcode, this is not sufficient in all situations where an individual needs to be identified.

There therefore exists a need to be able to distinguish between situations where information of different sensitivities and securities is needed, and to reduce the need to access additional security information from a trusted third party that is not stored on the identification document itself.

The present invention is defined by the independent claims to which reference should be made. Preferred features of the invention are defined by the dependent claims.

In a preferred embodiment of the invention, data sets that contain different types of information accessible by different parties are provided. This has the advantage that the need for all potential readers of the object to be able to access all information, and to contact a third party during the verification process is removed.

A further advantage is that only the identity object needs to be validated, no requests for confidential information need be passed to the individual being identified. This increases the confidentiality and security of the identification information stored in the system.

Further advantages of embodiments of the invention will be apparent from the appended dependent claims, to which reference should be made.

In an embodiment of a second aspect of the invention, a token is created defining a first identity object. On validation of this token, a second identity object is created which is linked to the first identity object and carries an indication that the first identity object has been authenticated. Further identity objects may be linked in the same way. This has the advantage that linked identities can be created for a series of linked events such as an airline ticket, a passport, a visa and passenger baggage. Each of the identity objects is different, so increasing security, but linked, enabling the passenger and related assets to be traced throughout a journey.

The present invention will now be described by way of example only, and with reference to the accompanying drawings in which:

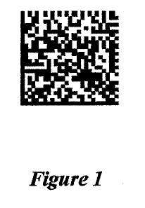

FIG. 1 is a view of a data matrix;

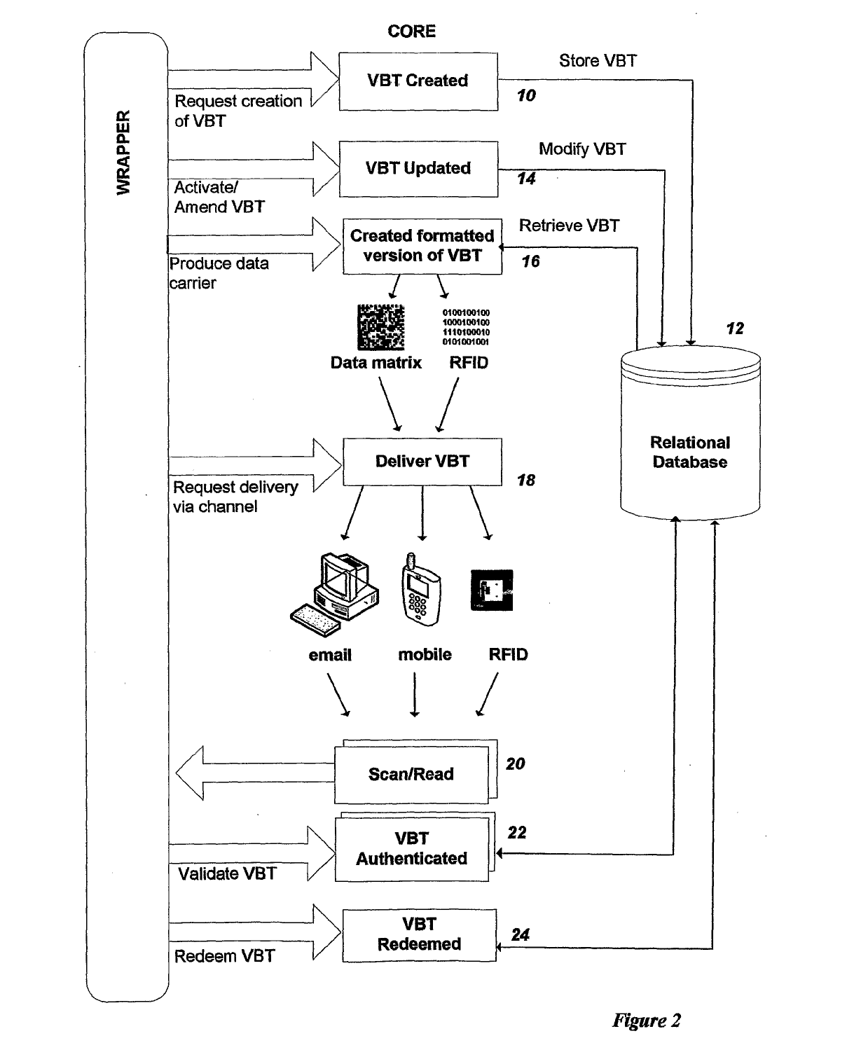

FIG. 2 is a schematic diagram of the core and wrapper of a system embodying the present invention;

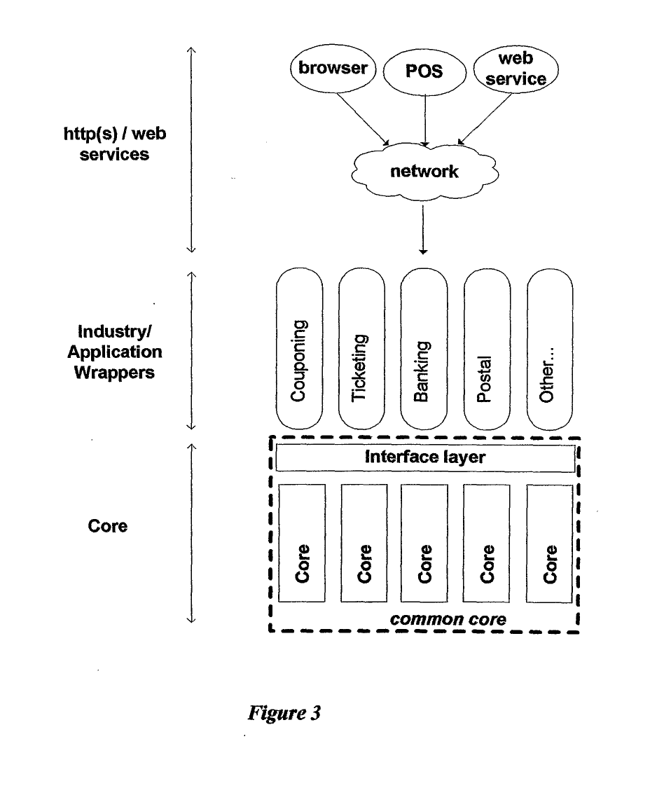

FIG. 3 shows how the core of FIG. 2 may be used with a plurality of different application wrappers;

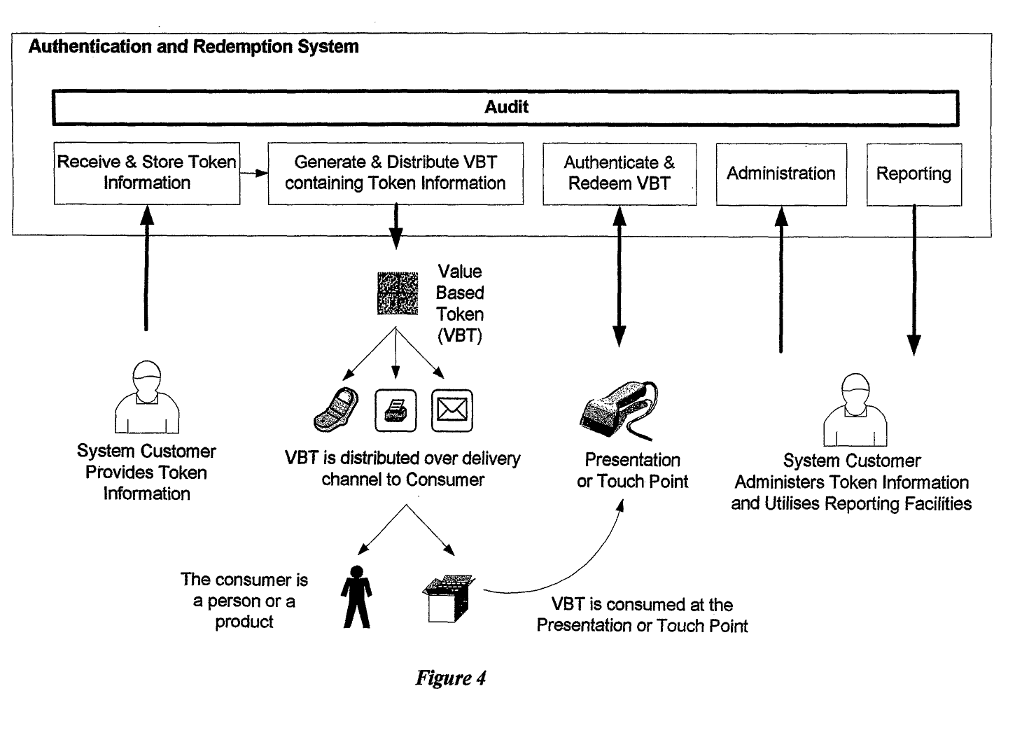

FIG. 4 is a schematic representation of the functionality of the system;

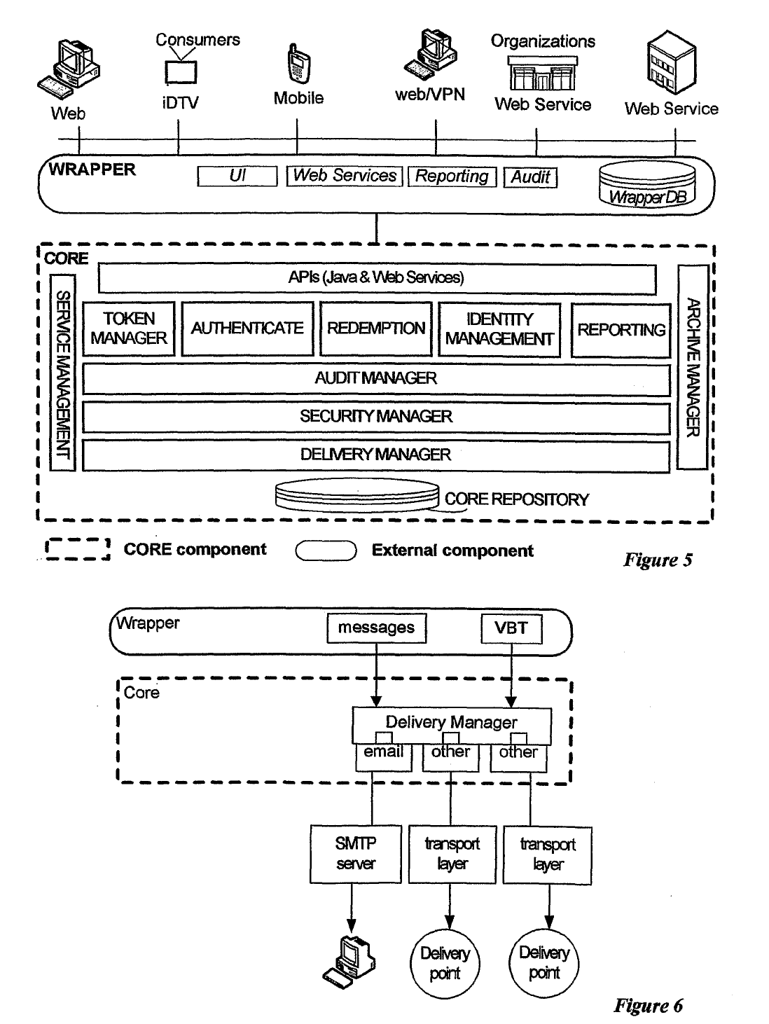

FIG. 5 is a representation of the software components of the core of the system of FIG. 2 providing the functionality of FIG. 4;

FIG. 6 is a representation of the functionality of the delivery manager of FIG. 5;

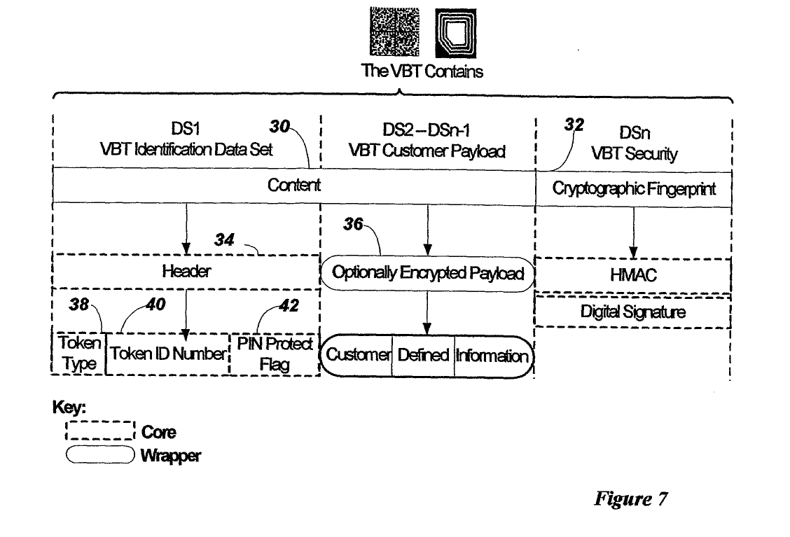

FIG. 7 shows the structure of a value based token embodying the invention;

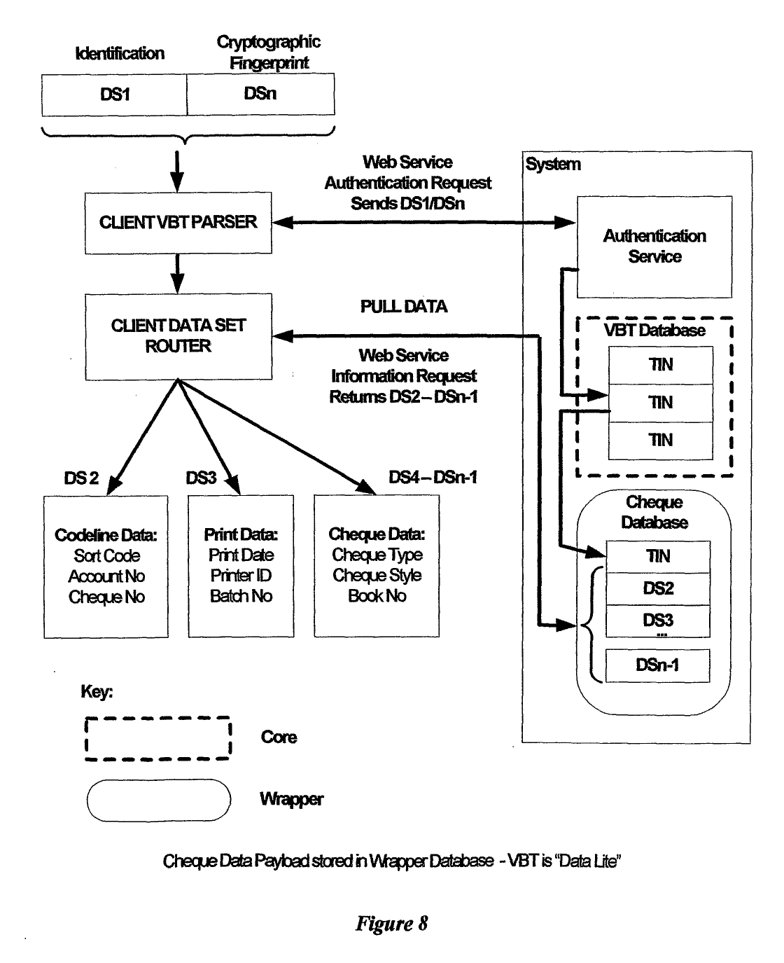

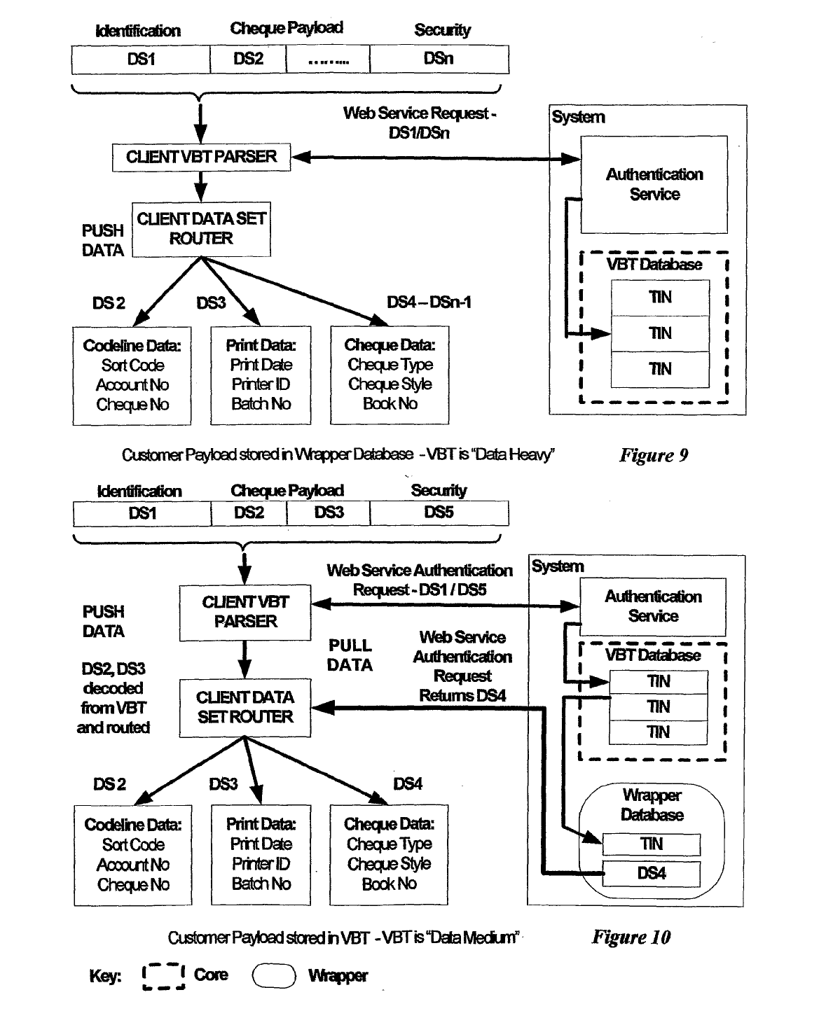

FIGS. 8 and 9 show, respectively, embodiments using data lite and data heavy value based tokens;

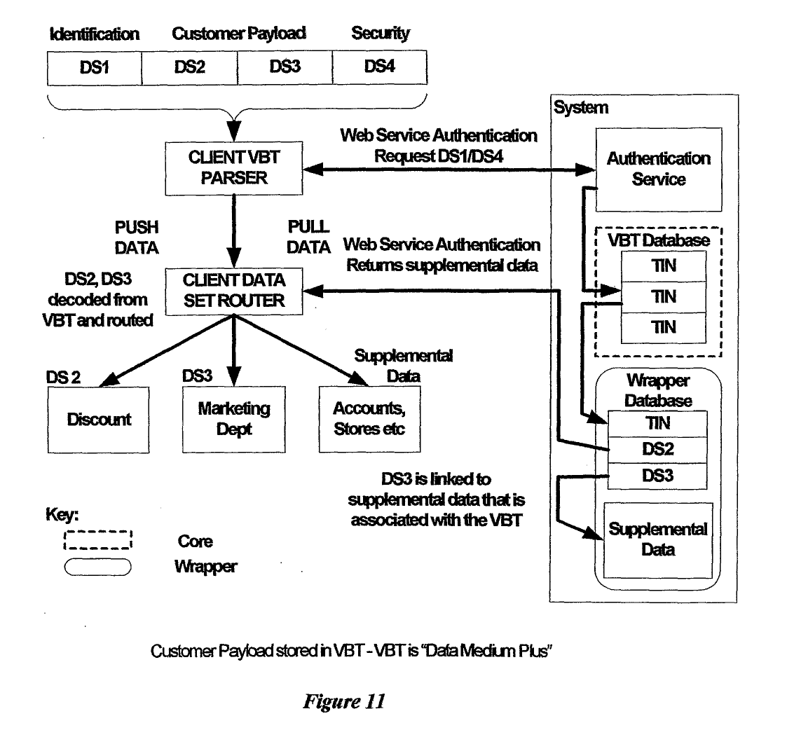

FIGS. 10 and 11, respectively, show VBTs having intermediate amounts of data in the token;

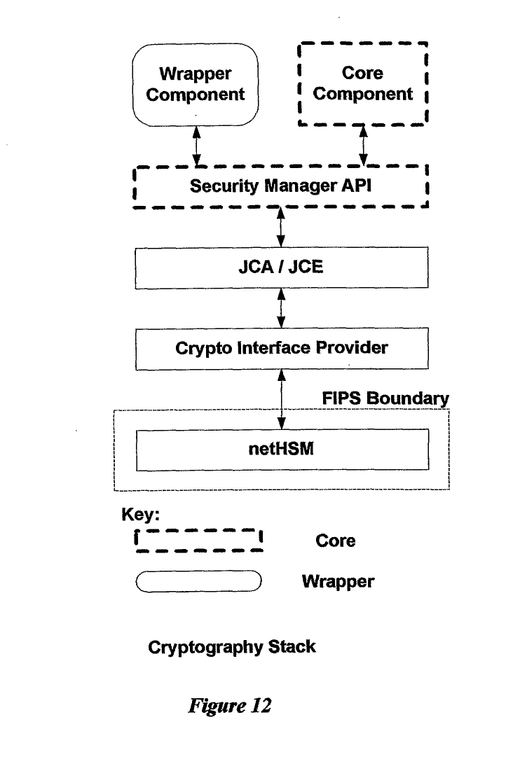

FIG. 12 is a schematic diagram showing cryptographic functions;

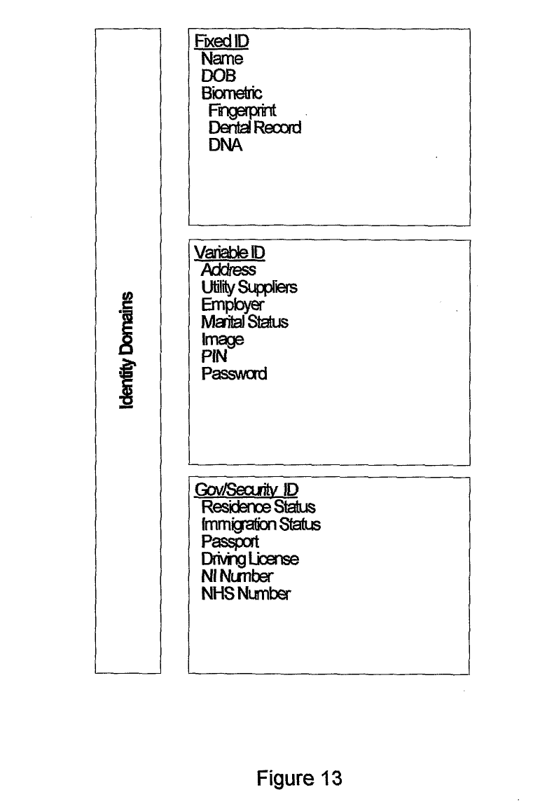

FIG. 13 shows a series of identification data sets or identity domains;

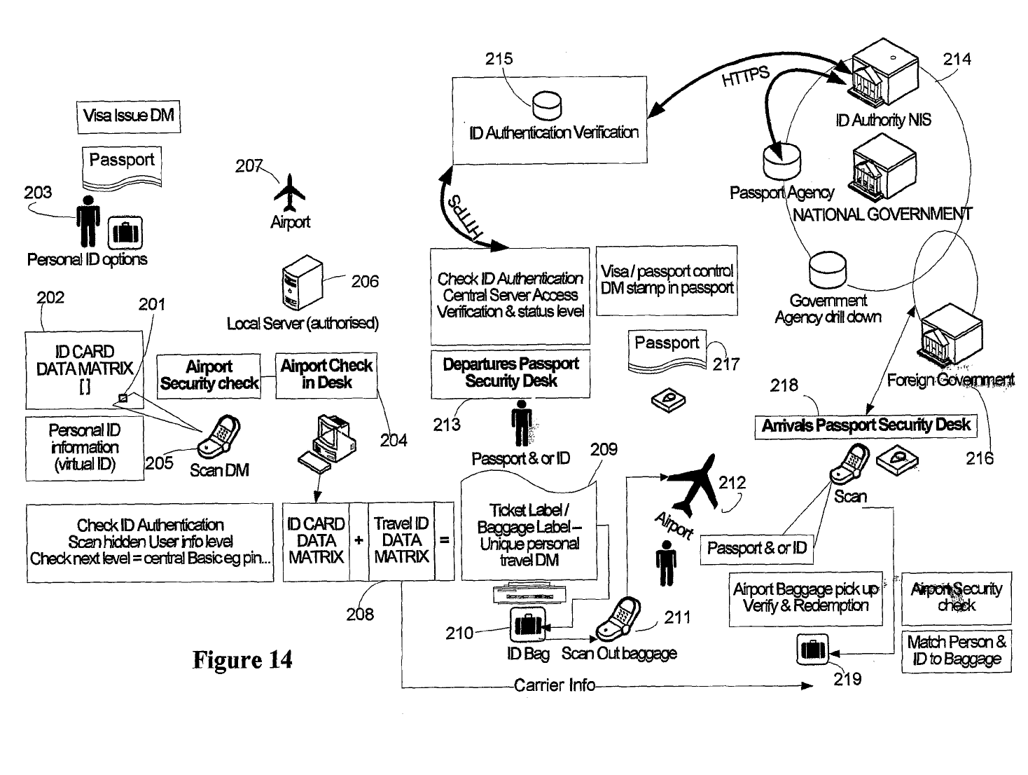

FIG. 14 is a schematic diagram showing the stages in use of an identity object according to an embodiment of the present invention;

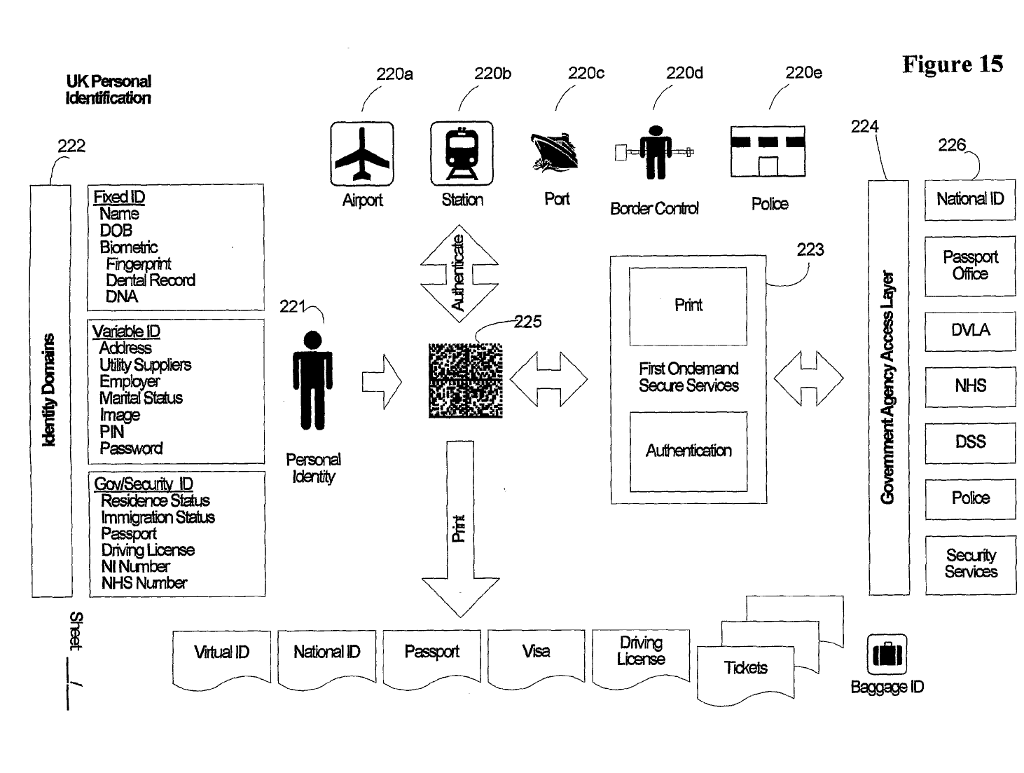

FIG. 15 is a schematic diagram of the relationship between relevant parties necessary to create an identity object, such as a passport;

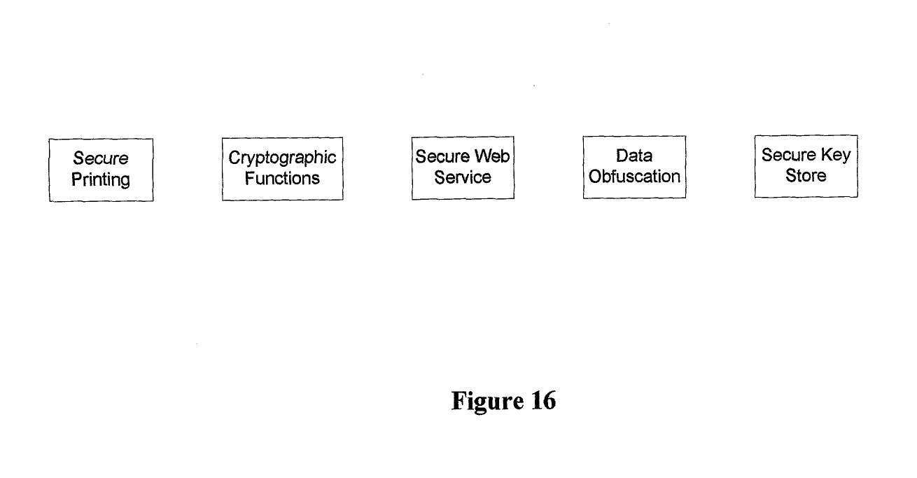

FIG. 16 is a schematic diagram of the components necessary to print an identity object according to an embodiment of the present invention; and

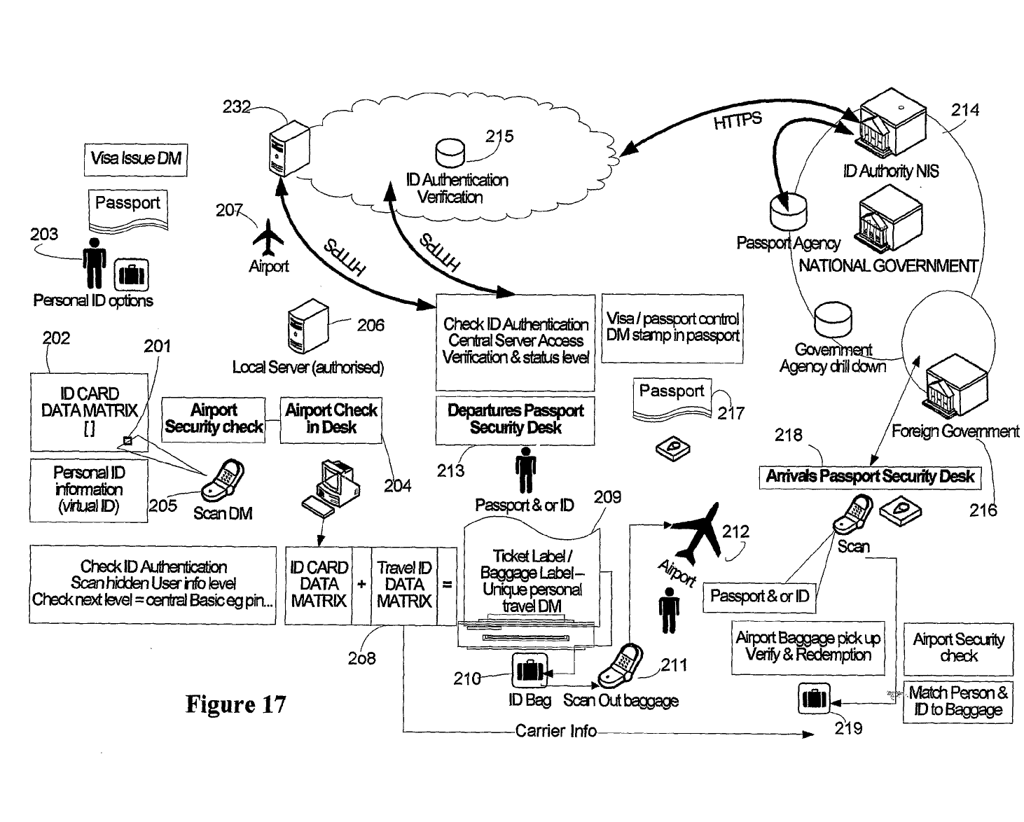

FIG. 17 is a second schematic diagram of the relationship between relevant parties necessary to create an identity object, such as a passport.

The system to be described provides a secure, web service based, authentication system for printed and other media types using data carriers such as Data Matrices and RFID. The system has a core generic part, which includes components that support generic functional requirements. The core components are extended on an application-by-application basis, or customer-by-customer to support specific industry requirements. These specific extensions are referred to as “wrappers”. The system is not limited to the Internet or World Wide Web but may be implemented on any type of network, for example a company private network. In many applications, embodiments of the invention will interface with existing networks of a user or set of users.

The system to be described may be used in a variety of different applications, but after describing the system generally, we will describe it particular application in the field of identification systems including identification of individuals and items. However, the system to be described has a much broader application which includes the following given as examples only.

Couponing: Adding a value-based token (discussed below) to a retail coupon. This enables the coupon to be validated at the point of sale preventing mal-redemption (fraudulent redemption) and mis-redemption (redeeming coupons for products not being purchased).

Banking: Adding a value-based token to cheques (for example, when a cheque is personalised during production by the bank and is printed). This can then be used within the banking environment to validate cheque details during the clearing process to reduce fraud. Alternatively, value-based tokens can be used to create personalised money, which may be redeemed by the user on a one-off basis.

Ticketing: Creating tickets as value-based tokens and delivering them via various channels: postal, email, mobile etc. This allows secure authentication and redemption of tickets at the point they are presented.

The concept of a value-based token (VBT) is fundamental to the design of the solution and is discussed here briefly. A fuller description is given below. A VBT is a mechanism that allows a unique entity to be created, printed (or delivered via another channel) and subsequently authenticated. All VBTs have a unique identity, the ability to store data and security features to prevent their content and structure being amended maliciously. For example, a VBT generated for a money-off coupon may contain a unique token number, details about the product the coupon can be used against and a message authentication code (MAC) used to identify if a token has been altered.

The preferred data carrier for the VBT is the Data Matrix (DMx). However, other data carriers may be used depending on the nature of the VBT and the data to be carried, and the geographical region in which the solution is to be implemented. The nature of the data carrier is described in detail below. Data Matrix is an encoding standard used to produce a 2-D barcode such as the one show in FIG. 1. It can be included in a document, on some other form of printed media or could even be applied to a product itself. At some point in the VBTs life it will be read (scanned) and then authenticated and/or redeemed by the system.

A Data Matrix encodes information digitally in the form of a checker pattern of on/off. Data Matrix is defined by ISO standard, ISO/IEC16022-International Symbology Specification, Data Matrix.

It is possible, in some embodiments of the invention, that the VBT will never be printed, for example if it remains in electronic form. In such a case, the VBT may not need to be encoded on a data carrier.

FIG. 2 provides an overview of the interaction between a wrapper (industry implementation) and the core. The core includes a database, for example an Oracle 10g database which holds data to be included in the VBT and data which is related to data held in the VBT, as discussed below. The core is responsible for creation, updating and delivery of VBTs as well as the creation of formatted versions of VBT for inclusion on the selected data carrier. The core is also responsible for the processing of scanned data carriers to authenticate them and to update the database to show that a given VBT has been redeemed. The wrapper holds information that is specific to an application so that, for example, where the data carrier is applied to a coupon, the wrapper will hold information that is specific to that application, such as the data structure of the VBT, the type of encryption used and the data carrier into which the VBT is to be formatted. This approach makes is simple to adapt the system to new applications for the VBT.

The various functions of the core shown in FIG. 2 will now be described in more detail.

Creation 10: During token creation, the core creates a unique identity for the VBT and stores it in the token repository (database 12). A VBT will carry data relevant to its application although it is not a data store in itself. For example, a VBT used to secure a cheque may contain the payee, account and amount. The wrapper is responsible for passing all application specific data to the core. Each type of VBT will have specific security requirements defined in a security policy. For example, a simple voucher may only need a message authentication code to prevent data being changed whereas a bank cheque may require encryption and a digital signature. The core will apply these security features automatically during creation. The structure of the VBT is discussed below.

Update 14: A wrapper may need to update a token during its life, usually to change its status. The core allows updates providing they do not violate the rules defined for the token type, e.g. a wrapper can change the token status from ‘created’ to ‘active’.

Format for data carrier 16: A wrapper can request that a VBT is built for a particular data carrier, for example a Data Matrix or RFID. The core chooses the appropriate software application for the data carrier and uses it to construct a VBT of this type. New providers can be plugged in to the core and configured for use via an administration interface.

Deliver 18: The core allows a wrapper to send tokens via supported channels. Messages sent via the core can use generic XSLT templates to format messages. Alternatively, a wrapper can construct a message itself and simply send it via the core. Messages may be delivered via email. Additional channels may require access to third party messaging gateways for example, to send SMS messages.

Read VBT 20: A VBT will be scanned/read at the point of use, for example a bank or a retail outlet. The content of the VBT can be used locally if required. However, to authenticate or redeem the VBT the content will be securely sent via the wrapper, e.g. a web service call. The wrapper can apply custom validation, business logic before using the core to authenticate and/or redeem the VBT.

Authenticate 22: The wrapper will pass the entire content of the VBT to the core for authentication. During this process the VBTs security features are used to validate its authenticity, i.e. PIN, MAC and signature. Where a VBT contains encrypted data the core will decrypt and return the clear text to the wrapper where additional processing can be performed.

Redeem 24: The wrapper will pass the entire content of the VBT to the core for redemption. The VBT will be checked by the core to ensure it is valid and if successful will update the VBT to a redeemed status. VBTs will normally be redeemed only once; however the core will allow tokens to be configured to allow multi-redemption of a single VBT. This may be required in some applications, where, for example, the VBT relates to a multiple entrance pass for a venue.

A typical deployment will include the core extended with a wrapper, which is a customisation for a specific application). FIG. 3 shows several deployments, each with their own wrapper. The wrapper may extend the core to implement additional data requirements, additional validation/business logic, customize the look & feel and provide a user web portal. In FIG. 3 examples of wrappers for couponing, ticketing, banking and postal applications are shown.

FIG. 4 shows the outline functionality of the system. There are five basic modules which are described in detail in relation to FIG. 5 below: Audit, Receive and Store Token Information; Generate and Distribute Value-based-token (VBT) containing Token Information; Authenticate and Redeem VBT; Administration; and Reporting. The receive and store token information module receives token information from customers who provide details of the data that is to be included in the token. For example if the token represented a money-off token, the identity of the token as a money-off coupon, and the token value, the product to which it relates and other parameters are supplied by the customer via a wrapper for that token type, as is described below. The generate and distribute module takes the token information and forms it into a value-based-token having a structure described below and then encodes the VBT onto a data carrier. The data carrier is then distributed to consumers over any convenient delivery channel such as, but not limited to, the postal services, email, fax, commercial print works and web-based distribution. The consumer is a person or even a product. The VBT may be applied to a coupon or the like that a person can redeem or may be applied to a product such a labelling or packaging. The authenticate and redeem module is responsible for verification of the authenticity of a VBT bearing data carrier when it is presented. The data carrier will be scanned and the encoded VBT recovered and verified by the system in a manner to be described. Finally the administration and reporting modules allow customers to interact with the system to provide them with selected information about the generation, authentication, and redemption of tokens by the system in accordance with their level of permissions.

FIG. 5 illustrates the software components that comprise the core. The core supports Internet and Intranet access via a browser which is also used to access the core administration interface and web service calls to APIs. Components are built using a J2EE development framework.

The following processes form part of the core solution. Each wrapper may use all or a subset of these processes to deliver the most appropriate solution

### User Account Creation

### User Account Maintenance

### Login/Logout and Session Management

Key management

### Token Creation

### Token Maintenance

Token Generation (format VBT for data carrier, e.g. data matrix)

### Token Encryption

### Multi-channel Token Delivery

### Token Authentication

### Token Redemption

### Multiple Token Redemption

### Token Batch Creation and Management

Unique Token ID generation

### Token History Reporting

### Audit Reporting

### Token Manager

The Token Manager component supports the creation and maintenance of VBTs within the core repository. It does not include any authentication or redemption functionality to provide additional security and deployment options. The token manager provides for creation of a unique entry in the core repository representing a VBT; maintenance of a history of all token events, e.g. creation, update etc. The token manager can specify an optional free text payload that will be contained within in the generated token. For example, this payload would be written to a data matrix or written to an RFID chip. This payload is referred to as the embedded payload.

The token manager can also specify an optional free text payload that is stored in the database. This payload is referred to as the additional payload. This payload will not be included when the token is generated. Additional payloads can be retrieved when a token is authenticated or redeemed. The token manager controls updating of a token's additional payload. A token can only have one additional and one embedded payload. A token's embedded payload cannot be updated unless it is in created status. If it has any another status it may already have been delivered, e.g. printed, and the delivered content cannot be amended. The token manager can specify an optional pin/password to secure a token. It is also responsible for activation and cancellation of tokens. Prior to activation any attempt to authenticate or redeem a token will fail. A token is only valid between its start and end dates. These dates include a time element. The token manager can create tokens for different data carriers.

A token's security features, such as whether it contains a digital signature, are defined in a security policy. The following combinations of token, wrapper (payload) and security data may be supported:

### Token

### Token+Payload

### Token+Payload+MAC

### Token+Payload+Digital Signature

The payload can be clear text or encrypted depending on the application. Every token event (creation, update etc) can be audited and a token batch can be created and used as a logical grouping of tokens. A batch includes a meaningful name. A token may be assigned to an existing batch.

The core supports an extensible token lifecycle so that new statuses and the valid transitions between statuses can be defined. The token manager can also redeliver an existing token, for example, if the original has been lost.

The operation of the token manager will be better understood from the following use cases.

| | |
|---|---|
| Use Case Name: | Create Token |
| Actor/Role: | Wrapper |
| Description: | Create VBT entries within the repository |
| Pre-Conditions | Wrapper is authenticated and authorised to use the |
| | service. Where a batch is specified the batch must |
| | already be created. |

### Flow:

1. Wrapper sends token details to the Token Manager component. As a minimum the token type is required. Other optional attributes include:

| | |
|---|---|
| PIN | Security code required when using token. |
| Payloads | Data to be carried with the token. |
| Start date | Date from which the token can be used. |
| End date | Date at which the token expires. |
| Status | Status to be assigned after creation. |
| Redemption Limit | Max times VBT can be redeemed (default 1) |
| Batch Identifier | Batch token should be assigned to. |

2. Validate that the token type is available for the current service.
3. Validate token details. The PIN preferably has an alphanumeric value up to 30 characters in length. If an additional payload has been specified, i.e. it will be held in the database, the token type must be validated to confirm this type of payload is supported. If a status other than ‘created’ has been specified it must be a valid transition from ‘created. The batch must exist.
4. Generate token identification number [TIN]. This will be generated via the Security Manager that provides random number generation. The TIN may, for example be of fixed length such as 16 digit numbers for the TIN. However it is preferred that the TIN length is configurable as this further increase the flexibility of the system.
5. Generate token key. This value is also generated using the Security Manager's random number generator. This is a unique internal key for the token which will be used when referencing the token externally, e.g. from an email. As the key is not embedded within the token it is more difficult for malicious users to obtain.
6. Retrieve the security profile for this service/token. This will determine how the token should be constructed. The security profile will include:

| | |
|---|---|
| Hash | Hash/HMAC function used for MAC |
| Signature | Cipher used for digital signature |
| Encryption | Cipher used for encryption |
| Method | Describes which security features to use. |

7. Apply security policy to generate VBT string. If required, calculate the message digest of the token header and payload using the Security Manager. One suitable standard is HMAC-SHA256.
If required, calculate the digital signature of the token using the Security Manager. One suitable standard is RSA-SHA256.
8. Create token and its payload(s) within the repository.
9. Create a token history record containing all the token details.
10. Write an audit record of type ‘TOKEN_CREATION’ for the event.
11. Return the TIN to the wrapper

| | |
|---|---|
| Use Case Name: | Update Token |
| Actor/Role: | Wrapper |
| Description: | Amend VBT details (e.g. setting status to ‘active’) |
| Pre-Conditions: | Wrapper is authenticated and authorised to use the |
| | service. Where a batch is specified the batch must |
| | already be created. |

### Flow:

1. Wrapper sends token details to the Token Manager component. In addition to the TIN the attributes may include:

| | |
|---|---|
| PIN | Security code required when using token. |
| Payloads | Data to be carried with the token. |
| Start date | Date from which the token can be used. |
| End date | Date at which the token expires. |
| Status | Status to be assigned after creation. |
| Redemption Limit | Max times VBT can be redeemed (default 1) |
| Batch Identifier | Batch token should be assigned to. |

2. In addition to the validation checks performed for these attributes in the ‘create token’ use-case the following checks should be performed. The embedded payload can only be updated if the token has a status of created. If a new status is specified it must be a valid and current transition as defined in the Token Management component.
3. Re-apply security policy to generate VBT string.
4. Update the token and payload (if amended) within the repository.
5. Create a token history entry in the repository.
6. Write an audit record of type ‘TOKEN_UPDATE’.

| | |
|---|---|
| Use Case Name: | Generate Token |
| Actor/Role: | Wrapper |
| Description: | Generate a VBT for specific data carrier (e.g. data |
| | matrix) |
| Pre-Conditions: | Wrapper is authenticated and authorised to use the |
| | service |

### Flow:

1. Wrapper sends request to the Token Manager. The TIN will be specified to identify the token. The wrapper may also use the attribute: Data Carrier. In a preferred embodiment, two data carriers are supported:

Text: Simply returns the raw VBT string.

Data Matrix: Encodes the VBT string using data matrix symbology.

### 2. Validate the TIN and Data Carrier.

3. Retrieve the provider (class responsible for encoding the VBT string) for the data carrier.
4. Encode the VBT string for the requested data carrier. For example, where the data carrier is data matrix a 2-D barcode will be generated using the data matrix image or font generator.
5. Return encoded VBT to the wrapper.
6. Write an audit record of type ‘TOKEN_GENERATE’.

| | |
|---|---|
| Use Case Name: | Create Batch |
| Actor/Role: | Wrapper |
| Description: | Create a batch (logical container for VBTs) |
| Pre-Conditions: | Wrapper is authenticated and authorised to use the |
| | service. |

### Flow:

1. Wrapper sends request to the Token Manager component. An optional batch description can be specified.
2. A batch is created with a unique identifier.
3. Return batch identifier to the wrapper.

### Token Manager API

The following Java API's will be exposed to wrapper modules. The APIs are built to allow new commands to be added as required without altering any existing API calls.

createToken—Create a token as per the use-case described above.
updateToken—Update an existing token subject to the use-case describes above.
generateToken—Encode the token into a Data Matrix or other token formats such as RFID.
createBatch—Creates a new batch in the token repository and returns its ID to the calling module.

### Authenticate

The authentication component is responsible for authentication of tokens when they are read or scanned.

If a token has been signed the signature must be validated during authentication. An invalid signature will result in authentication failure. If a token contains a MAC this must be validated during authentication. An invalid MAC will result in authentication failure. During authentication a check is performed to confirm that the token exists within the repository. A missing token will result in authentication failure. During authentication the token's start and end date must be checked together with its status. When a status is defined it will be assigned a flag that identifies whether it will cause authentication to succeed or fail. For example, a status of ‘created’ may cause authentication to fail and a status of ‘active’ may result in success. If a token has been secured with a PIN, the PIN should be supplied and checked as part of the authentication process. If the supplied PIN does not match the original value the authentication process will fail.

On successful authentication or redemption the additional payload is returned (if requested).

All authentication requests successful or otherwise should be audited. The manner in which the authentication component operates will be understood better from the following use cases.

| | |
|---|---|
| Use Case Name: | Authenticate Token |
| Actor/Role: | Wrapper/Web Service |
| Description: | Verify Token Details |
| Pre-Conditions: | Actor is authenticated and authorised to use the |
| | service. |

### Flow:

1. Wrapper sends token content to the Authenticate component. It also specifies whether the additional content should be returned on successful authentication and any PIN details specified by the user.
2. Retrieve the security profile for this service/token type using the service management component. This must be the policy in place at the time the token was created.
3. If a PIN is required to use the token the PIN value supplied must be processed to ensure it matches the PIN digest stored in the repository.
4. If the security policy specifies a digital signature use the Security Manager to validate the signature. If the signature is invalid return an authentication failure status.
5. If the security policy specifies a hashing algorithm use the Security Manager to validate the message digest. If the message digest is invalid return an authentication failure status.
6. Confirm the token exists in the repository and that its status contains a valid ‘authenticate’ flag.
7. Validate the tokens start and end dates.
8. If a token's redemption count must be less than its redemption limit (the maximum number of times it can be redeemed).
9. If all the above steps have passed the validation process returns a valid status to the actor and the additional payload (if requested)
10. Write an audit record of type ‘TOKEN_AUTHENICATE’.

### Authentication API

The following Java APIs support the authentication use-case above. Although a default authentication Web Service is part of the core most wrappers extend the authentication process. In this case the Java APIs can be used to support the requirements of their redemption process.

authenticateToken—using the security features on the token, this API verifies that the token is genuine and has not been tampered with.
authenticatePIN—compare the PIN stored against a token with a user supplied value.

### Authentication Web Services

AuthenticateToken—this service supports the authentication process defined in the above use-case. If the service consumer requests the token's additional payload it is returned only on successful authentication.

### Redemption

This component is concerned with redeeming tokens after they have been authenticated.

Before redeeming a token it must pass all token authentication tests. A token can only be redeemed if it has a status is flagged as ‘redeemable’. For example, the token statuses ‘created’, pending’, ‘approved’ and ‘redeemed’ may be defined and tokens may only be redeemed in they have a status of ‘approved’. A token can be redeemed more than once, with the maximum number of times a token can be used being defined for a token at its creation. By default a token can only be redeemed once.

All attempts to redeem a token are written to an audit log, and when successfully redeemed a token's status is updated to ‘REDEEMED’ (or to a specific status).

The operation of the redemption component is further explained by the following use case.

| | |
|---|---|
| Use Case Name: | Redeem Token |
| Actor/Role | Wrapper/Web Service |
| Description: | Amend token details (e.g. setting status to ‘active’) |
| Pre-Conditions: | Actor is authenticated and authorised to use the service |

### Flow:

1. Actor sends token content to the redemption service including any PIN details specified by the user.
2. Token is fully authenticated as per the Authenticate Token use-case. If authentication fails a failure response is returned to the Actor.
3. Token status is updated to ‘redeemed’ (or to whatever status the actor has requested, subject to transition rules).
4. Increment the redemption count.
5. Write the transaction to the audit log.
6. Return the redeemed payload to the Actor.

### Redemption API

The following Java APIs support the redemption use-case above. These can be extended to support a custom redemption process.

redeemToken—Redeem the token as per the use-case defined above.

### Redemption Web Services

RedeemToken—this service supports the redemption process in the above use-case. On success the redeemed payload is returned.

### Identity Management

This component only manages basic account information. This includes a ‘display name’ that may be used for reporting purposes and default values for e-mail address and/or mobile that can be held as default values for the appropriate delivery channels. Users of the system authenticate themselves using a username/password. Calls to service based functions (web services) can authenticate via username/password or Certificate Based Authentication (x509.3). An administrator may register new users via a User Interface (UI)

### Identity Management API

The following Java APIs are exposed to the wrappers.

authenticateUser—authenticate a user's credentials and create a new session.
isSessionValid—returns true if the current session is still valid.
getSession—returns the current session which can be used to identify the user's account and other session details.
maintainAccount—create and maintain user account details.
hasRole—returns true if the current session has been assigned a particular role.

### Identity Management UI

The following user interfaces are provided for the identity management component.

Login—Basic login screen. Username/password authentication.
Error Page—A generic error page used to display authentication, page access and general error messages.
User Registration—This screen allows administrators to create accounts for new users and assign them an appropriate role.

### Reporting

The reporting component is responsible for the reporting functionality. Reports will be called from the administration screens and provide flexible reporting based on audit records written by the core components. Redemption reporting can report on both successful and unsuccessful redemption attempts. Successful redemption records include the date/time stamp, account, token type and optional location id if provided by the web service. Failed redemption attempts include date/time stamp, account, token type, optional location id if provided by the web service and information about the reason for the failure. Each token listed in the redemption report provides drill down functionality to get further information about the token. Reports can summarise the status of all tokens or a subset of the tokens as defined by parameters provided to the report. This report accepts dates, service and token type as parameters. A status summary report provides a drill down to get further information about the tokens in each status. A token report by status lists all the tokens in the given status that fall within the parameters passed to the summary report. It is possible to drill down on each token. The complete history of a token can be reported and a status summary report is available to report on the tokens associated with a batch.

The core reporting functionality does not include management information in the preferred embodiment. This is implemented on a wrapper-specific basis.

The reporting included as part of the core falls into the following categories:

### Audit Reporting

### Redemption Reporting

### Token Reporting

The audit reporting provides parameterised reports on the application audit table. This report may be parameterised based on a date or date range, the service, the audit level or the audit type. Each of these parameters is optional.

The redemption report provides information about successful redemptions and those that have failed. The redemption report may be parameterised based on the service a date or date range and the token type. The report provides detail about the account and a ‘location id’ if provided by the web service. The failure report also includes any error codes that will provide further information about the reason for failure.

The token report lists a summary by status of all tokens within the system. This report has optional parameters of service, token type and date or date range. The token report by status provides information about the date the token was updated to the selected status and the account that requested the update. Each token will link to a token history report.

The token history report provides information on each status transition that the token has made. It will also report on the accounts that requested the transition, the date and any additional details that may have been supplied e.g. delivery channel, error code or location id. This report will include both successful transitions and transitions that have failed.

It will be appreciated that the reporting functionality available is highly advantageous as it allow tracking of tokens by the token creator. This may, for example, be the issuer of a money-off coupon who wants to track how many coupons have been issued and redeemed.

Audit Manager

The audit manager component handles audit requests. The core allows custom audit types to be defined (for use in a wrapper). Audit requests include an audit level. This allows the audit component to be configured to only record events within an audit threshold. All events associated with a token are audited and written to a token history. It is also possible to add a cryptographic seal to audit records, e.g. a digital signature produced using HSM, to provide evidence if the content of the audit record is modified.

Within the core components there are two types of auditing: Core Application Auditing and Token Auditing. The core application auditing allows audit records to be written for a range of actions. The actions that are audited are controlled at a service level. Each piece of audit information is categorised according to the Audit Type e.g. Login, UpdateReferenceData. Each Audit Type has an associated audit level. The level of audit required is associated with the service within the application reference data. Before an audit statement is written a check is made to see whether the audit record to be written has an audit level less than or equal to that defined for the service. Any audit record with an audit level in the correct range will be written to the audit able.

Each Audit Record will include the following information:

A date/timestamp indicating when the record was written; Information showing the type of audit record that is being written and the audit level assigned to that information;
The service that the audit record has been written for;
An optional message—to store non-standard details;
Information about the account that triggered the writing of the audit record—this will always populated unless the audit record is for something like a failed log in.
A separate table is populated to support the token auditing requirements within the core application. Each time a token is created or a change is made to an existing table. A record is written to a table that records information about changes made to the tokens. This provides a complete history of the token life cycle for each individual token.

Each Token History Record includes the following information:

The id associated with the token that has been created or updated;
The account that created or updated the token;
A date/timestamp indicating when the record was written;
A short description from a list of allowable values that will describe why the record was written;
A flag indicating whether the record has been written after a successful update or a failure;
Any error codes returned by the application will also be included in the token history record if the creation/update of the token was a failure;
If an activate call is made the delivery method and detail values are populated to record the route via which the token was delivered;
If the validity dates of the token are changed the new dates will be recorded in the history record.

If an authentication or redemption web service call is received that includes information about the location where the web service has been called from e.g. a till id/store id/merchant id this is stored in the history record.

### Audit Manager API

writeAudit—create an application audit record.
The core and wrappers can create data that is auditable to the highest standards. This allows the system to provide non-repudiable data. This ability is integral to the reporting linked to unique identities represented by the TINs and their authentication path. It means that value based transactions can be safely performed whether the value is monetary or otherwise. However with true audit level data sitting behind the normal reporting modules, linked to the client's wrapper behind it) “transactional monetary Properties” can be safely associated with it. Therefore when an authentication and redemption of a VBT representing a coupon, ticket, voucher note etc is done it can be linked to a real monetary transaction such as a micro payment or some other form of banking system like money transfer. This gives clients the ability to do financial reconciliation in real time if they require. The level of security and trust in the entire system allows a client to make real financial links and account in the true sense. Thus the presence of non-repudiable data is highly advantageous. One aspect of non-repudiation is time of creation. Reliance on system time is not sufficient as it can be manipulated. Embodiments of the present invention enable a non-repudiable time stamp to be applied to VBTs which can be relied on.

### Security Manager

This component handles security within the core and preferably uses the Public Key Infrastructure (PKI). PKI is a set of technologies, standards and procedures that define an enterprise-level security infrastructure. Components of PKI include:

Secret (symmetric) keys
Public and Private Keys (asymmetric keys or KeyPairs)
Digital Signatures, which use Hashing algorithms and Message Digests

All cryptographic functionality may be implemented using the Java Cryptography Architecture (JCA) and Java Cryptography Extensions (JCE) APIs.

The security manager seals tokens with a MAC which can be validated by the core. A digital signature can be created for a token using a service's private key and can be validated by the core. The content of a token can be encrypted using a service's private key and the content can be decrypted. The core supports generation of true random numbers, e.g. to produce token Ids, and stores a token's credentials (PIN/password) securely, e.g. using cryptography to store a message digest generated from the credentials.

### Security Manager API

The following security commands will be provided via a java API. The API is built to allow new commands to be added as required without altering any existing API calls.

createMAC—creates a message authentication code using the key/algorithm defined for the service/token type.
validateMAC—validate a token's MAC using the key/algorithm defined for the service/token type.
encrypt—encrypt data using the key and cipher defined for the service/token type.
decrypt—encrypt data using the key and cipher defined for the service/token type.
createSignature—create a digital signature using the private key and cipher defined for the service/token
validateSignature—validate a token's signature.
createMessageDigest—create a message digest using a specified hashing function, e.g. to create a PIN hash.
generateTRN—generates a true random number.
applySecurity—apply a security policy to a VBT.

### Delivery Manager

The delivery manager enables messages (which may include a VBT) to be sent via different channels. The delivery manager is an extensible component allowing support for new channels to be developed and plugged in without modifying the interface between the wrappers and core and is shown in FIG. 6.

The core supports multi-channel delivery of VBTs which may, for example, include email delivery. A message template may be defined that will be used to deliver a token via a specific channel. Whenever a token is sent via the delivery service an audit record is written.

### Delivery Manager API

SendMessage—delivers a token via a specified channel using a template defined for the service/token type.

### Service Management

The token management component allows an administrator to create and maintain the reference data associated with a token. An administrator may create a service via a user interface (UI). The Service Management UI enables an administrator to assign supported token types to service, and to create and maintain service roles. The administrator can create and maintain token statuses and configure tokens to enable or disable the use of additional payloads. A token status indicates whether redemption is possible and also indicates whether a token would pass authentication in this state. An operator may update token details in a batch, i.e. the same change is applied to multiple tokens for example, activating all the tokens in a batch. The core can support an extensible token lifecycle, making it possible to define new statuses and the valid transitions between statuses.

As there are a number of tables that need to be populated in order to configure the core components, there is a requirement to provide administration functionality to support updates to these tables. Administration functions and screens are only required for tables where the account holders or administrative account holders need to be able to make updates. A range of administrative functions is required to manage accounts within the core components. These functions allow for the creation of accounts and account maintenance. Whether these provide “self service” functionality or “administrator-only” functionality is determined at a wrapper level by the implementation of appropriate account types.

These functions maintain the tables within the core component schema and also the basic information that will be held in the LDAP directory to support login functionality. All administrative changes that are made by application screens are audited using the appropriate audit types so that a full history of the changes made and the actioning accounts is maintained.

### Service Management UI

Administration Screens may provide for the following:

Service Configuration—this screen allows administrative users to update the audit_level, error_level and audit_method of the service. The service information screen also allows the security policy associated with the service to be updated.

Communication Templates—the screen allows templates (e.g. an email template) to be created and updated by users with the appropriate permissions. Service/Account Mapping—a screen and/or API is provided to add new accounts to the appropriate service. An account must also be assigned an account type for each service to define the level of access the account holder has. The administration screen also allows for updates to the account type.

Account Types—A screen is provided to create account types and associate them with the appropriate roles to define their usage of the core components. The screen also allows administrative users to maintain the roles associated with account types.

Audit Types—A screen is provided to maintain the audit types available within the system in case any of the audit levels need updating.

Service Delivery Options—A screen is provided to maintain the delivery options that are available on a service-by-service basis. This screen will enable administrative users to switch delivery options on and off for the appropriate service.

Token Statuses—this screen allows administrative users to create and maintain token statuses.

Token Status Transitions—this screen allows administrative users to define valid transitions between token statuses.

Security Policy—this screen allows administrative users to define and maintain token security policies. These policies define the security

Update Token—Maintain existing token details, e.g. change status, end date etc. requirements used during token generation, e.g. should a digital signature be created, using which algorithm.

Reporting—menu access to the reporting homepage

The database used in the core may be any suitable database such as an Oracle 10g database.

The structure of the value based token (VBT) will now be described in more detail.

FIG. 7 shows the structure of the VBT. The token contains a contents portion 30 and a security portion 32. The contents portion 10 is divided into a header portion 34 and a payload portion 36. The header comprises a first data set DS1, and the payload contains a number of further data sets DS2-DSn−1. The security portion comprises a further data set DSn. Typically the header will contain a data set having at least three sub-data sets. The first 38 identifies the type of token. This is required in any open system in which the token could represent a number of different things such as an identifier for a medical prescription or an identifier for virtual money. The Token type data set identifies the nature of the token. The second data sub-set is a Token Identification Number (TIN) 40. The TIN is a unique number that identifies a particular token. The Third data sub-set is a PIN (Personal Identity Number) 42 and comprises a flag. Depending whether this flag is set on or off, the person presenting the token for redemption will be required to validate the token with their PIN number which will be compared with a number stored in the data set 42. The header section appears in all tokens whatever their application. It uniquely identifies a token and indicates whether the token is PIN protected. Thus the header content is:

| | |
|---|---|
| header: | <type><tin><pin flag> |
| Type: | Identifies the type of VBT (5 digits) |
| Tin: | Unique VBT Identifier (16 digits) |
| Pin flag: | Flag indicating pin requirement (1 digit |

Preferably, the header is not encrypted. This is important in an open system in which the token type must first be read before a decision can be made as to what token type it is and, therefore, how it should be processed. The header, therefore contains information about the token itself.

The payload will vary depending on the nature of the token and its application. It contains information, which is related to the use to which the token is to be put. In order to reduce the data content, and thus to enable the VBT to be encoded in a relatively small data carrier such as a data matrix, the actual data need not be stored in the payload. Instead an identifier is stored which, when read, enables data associated with that identifier to be retrieved from a database. Thus, for example, the database at the core/wrapper or elsewhere may store the bank account number, cheque number and sort code number of a cheque, together forming a bank identity. The payload merely holds data, such as an address that is sufficient to retrieve this bank identity from the database. The payload may be encrypted but it will be appreciated that the system is inherently secure as the information stored in the payload is meaningless, even when decrypted, without access to the database.

The content of the payload is specific to a wrapper and may even be omitted in some applications. The payload may comprise a plurality of data sets. In the description of the core above, these may comprise one or more datasets that are an additional payload and may be a reference to data or relational structures that are stored elsewhere, for example in the core repository. Each data set may be intended for a different purpose, for example for a different party or service.

Thus, the content part of the Value Based Token comprises a header data set which contains data about the token itself which may be unencrypted and may be divided into a number of sub-data sets; and a payload data set which may be encrypted and which contains a reference to data relating to the subject of the token enabling that data to be retrieved.

If the token's security policy specifies that the payload is encrypted the cipher (encrypted text) will be stored in the payload. Due to the binary nature of encrypted data it will be base encoded before storing it in the VBT. One suitable encryption algorithm is the AES symmetric algorithm for encryption of payload content. Thus:

Payload content: <free text>1<cipher text>

The security mechanism 32 will vary according to the intended use of the token and the type of data carrier on which is encoded. The security mechanism is a cryptographic fingerprint and protects the payload and header from tampering and counterfeiting. For example, the security mechanism may comprise a SHA 256 Hash or an RSA Digital Signature. A Hash has the advantage of being small in size and can be generated quickly, whereas a digital signature is larger and takes longer to generate and verify, but is inherently more secure and non-repudiable. The appropriate security mechanism will depend on the use to which the token is being put and the degree of security required. For example, a token which represents a small discount on an item form a supermarket will require much lower security than a token that represents personal cash or a cheque.

Thus, the content and size of this section is determined by the security profile defined for the token type and the key strength used in security algorithms.

Security content: [<message digest>|<signature>]

Message Digest If the security policy specifies a hashing algorithm, the message digest is produced by the hashing the <header> and <payload>.

Signature: Where a signature is specified in the security policy the <header> and <payload> sections will be hashed and the resulting message digest signed with the service's private key to generate a digital signature. Due to the binary nature of message digests and digital signatures values will be base encoded before storing in the VBT.

It follows from the foregoing discussion of the core and the wrapper that the core defines the structure of the VBT and that the core also preferably defines the header and the security portions. The wrapper for that application may define the payload contents, which are specific to each application. Thus the syntax and semantics of the header and security portions are defined in the core as well as the supported encryption algorithms for the customer payload. The complete VBT is stored in the core but the payload is defined and constructed in the wrapper. If the payload contains references to other data or relational structures, for example due to capacity constraints of the data carrier, these too will be defined in the wrapper.

FIGS. 8 and 9 show how different VBTs can be constructed, depending on the application and the data capacity of the data carrier. FIG. 8 shows a data heavy VBT and FIG. 9 a data light VBT. In FIG. 8, the payload contains 1 or more data sets which, when read, are routed through a local data set router 100 which communicates with the system server 102 to authenticate the token TIN and routes the payload data sets to different end points. In the example of FIG. 9, there are three data sets in the payload: DS2, DS3 and DS4. DS2 is routed to a local authentication points such as a till, DS3 is routed to a marketing department and DS4 is routed to some other end point. An individual data set may be routed to more than one point, and the data in the data sets may have a degree of overlap.

In the FIG. 9 case, the VBT is data lite and comprises a header and a security section only. The payload is stored at the core server and referenced by the TIN in the header. In an alternative, not shown, the payload could include a data set that is a reference to data or relational structures stored elsewhere.

FIGS. 10 and 11 show intermediated cases where the payload carries some actual data but also references data stored elsewhere. In FIG. 10, the payload includes data sets 2 and 3. A fourth data set is stored at the wrapper database are is pulled when the TIN is provided for authentication. In the FIG. 11 example, one or more of the data sets in the payload is linked to supplemental data, shown as stored at the wrapper database. Thus, the TIN references the data sets and the supplemental data. This again reduces the amount of data that needs to be carried in the VBT.

FIG. 13 shows the lifecycle of a VBT. A token may exist in a number of states: Created, suspended or redeemed. A change in status may occur through the activities of activation, cancellation or authentication.

The content of the VBT depends not only on the intended use of the token, but also on the nature of the data carrier that is going to be used to carry the VBT. Many types of data carrier are available. The data carrier is a portable data transport medium and, must be capable of storing identity data string components. A data carrier is usually a type of barcode or RFID device.

The data transport is constructed to have the generic format of the VBT:

| | | |
|---|---|---|
| Header | Payload | Security |

By using a common VBT for all applications, the common format and approach can be adopted even though different markets and applications have different requirements on how to place ‘identity’ data (or portable credential) onto an item and what that data item must include. For example, the level of security used may vary from minimal to very high. This has an implication on the amount of data that must be held in the data carrier and, in turn, what data carrier is appropriate. At one extreme, the VBT may have just a header and a security portion having low security. At another extreme, the VBT may include high security and a payload having several data sets each including a large amount of data. In between these extremes, the payload may have one or more data sets one or more of which may comprise a reference to data stored elsewhere.

Existing 1D barcodes (for example EAN 13 and EAN128) and 2D symbologies need may be used. Examples are QR code and Maxi code, and the Data Matrix (DMx). PDF 417 barcodes, RSS (Reduced space symbology) codes and RSS Composite (1D plus 2D) may also be suitable.

Embodiments of the invention may be used in environments in which a chosen Data Carrier is already used, whether it is a printed or marked barcode or a RFID type carrier. This pre-existing barcode type may be required for the solution as already have printing devices and scanning technology. In some cases, the VBT may be added to existing data carriers, such as a carrier used by a customer for other purposes. This is particularly possible on RFID devices which have a relatively large storage capacity but may also be possible on other carriers.

It is possible to create hybrid data from the actions and status of a client or consumer, for example by updating information and/or the data sets to create a new VBT either on the existing or a new data carrier. How the new hybrid VBT is sent to the data carrier depends on the Wrapper but follows the same route for its predecessor but may occur at a different place. In a particular solution user Rules may be require the first carrier to be scanned again before the second is scanned providing a two part verification process building a authentication picture. This is desirable, for example, in a ticketing situation. For a coupon the new VBT may be an update of where a customer had used the coupon and what status had changed, ready for the coupon to be used again. In this context a receipt printed at a till could easily print out a new carrier.

Table 1 below shows a number of examples of data carriers that may be suitable for use with embodiments of the present invention, depending on the requirements of the application.

TABLE 1

1D Barcode type (traditional range) eg EAN 13 or 128
Data Matrix (ISO/IEC standard 16022)
QR Code (ISO standard 18004)
PDF 417 (ISO standard 15438 - June 2001)
Maxi Code -
Vericode
RFID - all types (including Gen 2) also known as Radio Barcodes)
CHIP -

Thus, the VBT is first created and holds the final identity output created in the system core before it is encoded onto the data carrier of choice. The VBT has header, payload and security components as specified in the wrapper that is specific to that application. Encoding the data into/onto a Data Carrier will not alter the information of the original VBT data string. Therefore in the example of the DMx it would turn the VBT into a DMx image which when scanned would translate back into the original VBT content. In an example of RFID the VBT would be onto the RFID tag.

It is preferred to optimise all data to suit the data carrier type. This may involve using specific character sets or Base encoding to reduce unnecessary content overhead such as encountered when creating a DMx. Some data carriers have specific input formats.

In some applications, the data carrier will be held by a third party. An example is a manufacturing company who have their own data carrier (DC) generating software. A DC output can be an image or more common to a font generator so is treated like text. The font must be installed on the processing machine to see or print the image. The VBT may be sent out raw from the system for encoding by the customer.

When the system described serves a Data Carrier output, for example a DMx, it needs to suit the client's requirements. If a client has different delivery channels: mobile, print via web, print to print company, print to marking technology etc. then the solution must be able to serve the optimal output for that channel. This is relevant to all 1D barcode and 2D symbologies where if an output is to an image format rather than a “font” then the physical size, dpi or pixel size has to be considered and matched to the requirement. In an example where a consumer could choose from a range of options to collect his coupon such as phone, home print etc, kiosk the system is able to create specific graphic outputs.

In one embodiment of the invention, more than one type of carrier output may be provided. For example, an RFID tag may be used with a traditional printed barcode. In that case, the system may supply two identities: the DMx and RFID information. These identities may be the same but allow for different scanning routes. In one embodiment of the invention, where a single DMx, or other chosen data carrier, is not able to contain all the data or where 2 identities need to be issued to a single item (containing different information or for different uses), then two or more data carriers may be issued.

FIGS. 8 to 11 also show how a data carrier with an encoded VBT may be read. The data carrier is first scanned to recover the VBT. The header in the VBT is not encrypted and from this the scanner, shown as the VBT Parser can determine the nature of the VBT. For example, it may identify the VBT as a coupon, a cheque, a ticket etc. This may affect the way in which the recovered VBT is processed. In FIG. 8 the VBT is constructed as data lite, which means that there is no payload. The TIN in the header is used to authenticate the wrapper and is used to access data sets that are stored elsewhere. In FIG. 9, the VBT is data heavy and the datasets are in the VBT payload. Thus, in FIG. 8, the VBT is recovered by the VBT parser, which sends an authentication request including the header and cryptographic fingerprint data sets to the authentication service. The TIN is recovered and compared with the TINs stored in the core repository, and if there is a match and authentication confirmation is sent to the parser as described above. In addition, data that is associated with the TIN, which is shown stored in a wrapper repository, but which could be elsewhere. This data comprises one or more data sets and may comprise data that is in the payload in the data heavy example. These data sets are pulled by a data set router and distributed to on of a number of recipients. As shown in FIG. 8, different recipients may receive different data sets although it is possible for each recipient to receive any or all of the data sets. In the FIG. 9 case, the data sets stored in the wrapper database in FIG. 8 are already part of the VBT and are pushed by the client data set router to their intended destinations.

The data-lite model for the VBT shown in FIG. 8 enables discretionary (DAC) and mandatory access controls (MAC) to be placed on the content referenced by the TIN in the core database. Discretionary access controls are generally granted by a person such as the object owner and determine read and write access privileges to the object to users and groups of users. Mandatory access controls are enforced by the operating system or database and protect classified data that has been protectively marked or labelled from being inappropriately accessed or disseminated to those with insufficient security clearance. This is a multi-level secure (MLS) implementation of core suitable for Government applications such as a National Identity card scheme.

For a VBT that represents the identity of a person in the form of a serial number, this scheme can be used to control the type of information that is returned about that person. In order to implement this level of control the core database needs to know who is making the request; what role the person is fulfilling; and the location from where the request is being made. This identity based information can be obtained from an X509 certificate identifying the client making the information request. The client is a trusted node in the network with a pre-defined security clearance.

The manner in which a data carrier may be presented to a user may vary according to the application. For example, where the VBT represents a coupon for redemption in a supermarket or other store, the user will access the website of the supermarket or a particular supplier or manufacturer and be able to download the coupon. This will involve a VBT being generated and encoded onto the data carrier as described above. The user can then print the coupon including the data carrier a present it for redemption at the supermarket checkout. Alternatively, the coupon need never be printed but may remain in electronic form for redemption against electronic purchases.

Thus embodiments of the invention use a value based token which is encoded onto a data carrier. The VBT comprises a clear header, a payload, which may be encrypted, and a security section. The header is a data set which allows the VBT to be identified and may comprise a number of sub-data sets. The payload is a further data set, which contains information, which allows a reader access to data. The payload could be split provided that the reader is able to distinguish between two different data sets. As the payload does not contain actual information about the token, but a pointer to where that information is stored, the security of the token is improved. Moreover, the token is far more flexible that prior art examples which are limited by the ability of the data carrier, such as a data matrix or bar code to carry information. As the information about the token is not actually held in the payload, this problem is avoided.

The VBTs are generated, stored, authenticated and redeemed by a system, which comprises the core and one or more application specific wrappers. This approach provides a system, which can generate tokens for a wide range of applications with all common operations being performed by the core and application specific operations performed by the application wrapper. Thus, different data carriers may be used, or different payload structures used without affecting core operations. This is highly advantageous.

FIG. 12 shows how cryptographic functions are handled. All cryptographic functionality may be implemented using the Java Cryptography Architecture (JCA) and Java Cryptography Extensions (JCE) APIs. The cryptographic functionality within the core may use nCipher's netHSM Hardware Security Module (HSM). The netHSM is a FIPS140-2 Level 3 validated security boundary, i.e. a proven certified security boundary meeting cryptographic best practice. As shown in FIG. 16, the HSM is accessed using nCipher's JCE provider implementation (nCipherKM JCA/JCE CSP) to perform encryption, decryption, key generation etc. Other JCA/JCE providers could be used.

Having described the core system and its operation with various application specific wrappers, we will now describe how it may be used in the storage, use and portability of identity information or data relating to an individual or article. Embodiments of the present invention provide a way of generating an identity object that contains information regarding the identity of an individual or article. In addition, the object may contain information to enable a party reading the identity object to access records held in remote databases, rather than on or in the identity object itself, such as access codes or passwords. Once the identity object has been generated electronically, it can be transferred to a portable medium, such as a printed graphical symbol, an RFID tag or a secure chip. The identity object can no longer be altered by the individual, and is effectively locked and secure. Whilst the identity object holds all relevant information, it may not be possible for all parties to see all of the information. Access is determined by various permissions, and a party may only be authorised to view a subset of the information held on the identity object.

It will be appreciated from the above, that the identity objects are generated as VBTs by the core system which interacts with a wrapper which specifies the parameters of the VBTs. Although identification information is held on the identity object, it can also carry encoded access permissions to enable only trusted parties to view relevant levels of information or access codes to enable trusted parties to access remote, secure databases for additional information. In particular, one type of additional information that may be stored is a secure key to enable access by a trusted party to a remote secure record. The record may contain additional identification or other relevant information. The key may be redeemable, in that once used, the access to the record is flagged, and the record cannot be accessed again. In this manner, it is possible for a trusted party to collect secure information remotely. Thus, the manner in which the VBTs hold information many be according to the data lite, data heavy of data medium models discussed above. It is presently preferred to use the data lite or data medium approaches for a number of reasons. First, with regard to data capacity, it is necessary for the data matrix or other carrier to be rugged and capable of being read if damaged. It must also be relatively small and therefore it is not preferred that all possible information is stored in the VBT payload.

A second consideration is security. A number of problems exist with systems that store sensitive data such as biometric data on a chip or RFID type tag placed on an ID card, passport or similar document. Chips and tags can be scanned from a distance and their information retrieved; creating the opportunity for those identities to be captured by unauthorised and unseen persons who may wish to either recreate that identity, see where that person is, or gain other personal details.

Chips & Tags are also easy to damage electromagnetically, without showing visible signs, so information becomes irretrievable even by a genuine point of authentication.

Different authentication points may implement official authentication readers, using locally based technology, in various ways, which may lead to false positive readings about the identity being scanned. One machine in a location may read it correctly another may not. For a user of such an identity card this presents, at the very least, inconvenience but at worst a real threat to their liberty.

The system described above with respect to FIGS. 1 to 12 preferably works with other anti-counterfeit devices as a secondary secure authentication mechanism. The VBT may, using the data lite or data medium model, contain some payload data. This may, in the case of the data medium model, comprise fragments of biometric or personal data for direct comparison to that held on the chip, or, in the case of the data lite model, non-biometric data and only reference the authentication database. This database firstly confirms the validity of the card, and secondly allows an official person to gain access to other details held on the authentication database or other databases. The levels of access granted to various officials control how far they can drill down into the data stored at the authentication database and ensure that they only have access to information relating to that card. The VBT is preferably stored separately from any chip or tag that is used, and may be on a separate data carrier, such as the data matrix described above.

The data-lite model for the VBT enables discretionary and mandatory access controls to be placed on the content referenced by the TIN in the core database. Discretionary access controls are generally granted by a person such as the object owner and determine read and write access privileges to the object to users and groups of users. Mandatory access controls are enforced by the operating system or database and protect classified data that has been protectively marked or labelled from being inappropriately accessed or disseminated to those with insufficient security clearance.

For a VBT that represents the identity of a person in the form of a serial number, the type of information that is returned about that person can be controlled. In order to implement this level of control the core database needs to know who is making the request; what role the person is fulfilling; and the location from where the request is being made

This identity based information can be obtained from an X509 certificate identifying the client making the information request. The client is a trusted node in the network with a pre-defined security clearance. Web service requests containing these credentials are authenticated and a security clearance for the session is derived.

The use of a PIN flag placed on the VBT, as discussed above, allows a user of the card to assign a PIN, which is held on the authentication database. The use of such a PIN allows a card to be authenticated by non-official bodies such as retail shops or travel points. Because the PIN is not stored on the card the PIN can be added or changed by the user by logging into a secure site administered by the appropriate authority upon proper authentication of that person's credentials. Such as are given when logging on to a typical online bank account. It is important to note that existing Chip & PIN credit and debit cards store the PIN on the card and that PIN is verified locally.

As will be appreciated from the above discussion, the VBT may be used to provide a number of different data sets, either provided within the VBT or referenced by the VBT and stored elsewhere. Each set of data may be individually encrypted, giving rise to variable security levels and access permissions. Some sets of data may need to be accessible by different authorities, and therefore be stored more than once, with each set of stored data being encrypted differently. Only one data matrix is therefore needed to store a plurality of data sets or references to a plurality of data sets having various levels of associated security and access permissions. As a consequence of these access permissions, a party may be able to scan data from a data matrix that remains secure and confidential and hidden from that party, as they do not have the required access permissions to read the data directly or access the remote database at which it is stored. For a party creating a portable identity object, the party may be able to print hidden data.

Different encryption algorithms are used depending on circumstances, such as the nature of the ID or person or item carrying the ID. It is a feature of the data matrix symbol that it can include a large amount of redundant data. This enables error correction to be included in the encryption that makes the symbol more robust. Even if the symbol is partially damaged it can still be decrypted.

Many methods of encryption exist, and the type of encryption that is suitable in a given application is a question of choice for one skilled in the art. In addition to the approaches discussed above with reference to FIGS. 1 to 12, one approach is to use public/private key encryption in which the public key is stored on the data matrix in encrypted form and a private key is stored in a database and can be used to authenticate the public key. The public key is freely available, and linked to an identity certificate of the owner.

When public/private key encryption is used, it is necessary for a trusted certificate authority to issue a certificate and digital signature to the party printing the data matrix. The certificate itself can be validated by the issuing authority, which also holds a Certificate Revocation List and Key History. The Certificate Revocation List contains a list of all certificates that have been revoked, and is separate to a list of expired keys. A list of expired keys can be used to re-issue keys and ensure that the keys are varied. A key history is necessary to allowing tracking of individual keys throughout the lifetime of the data matrix, for example, for the duration of a passport containing the data matrix. The list of expired keys and the key history can therefore be used together to reduce the likelihood of any compromise to the data matrix security.

If public/private key encryption is used, then when printed, a hash is prepared from the intended data content of the data matrix. The hash is then encoded with the signing algorithm of the printer's private key, and a digital signature and copy of the public key are provided as part of the data matrix. On validation, the public key is used to prepare a hash, using the same signing algorithm as the private key, and is compared with the original hash. If the two hashes are the same, the data matrix is validated and is proved to have been unchanged since the original signing. It follows that the hash may be of a reference to a remote database at which actual data is stored.

The unique information that is printed on the data matrices is both stored in a central store or database and represented as encrypted data using proprietary algorithms to prevent the information printed in the data matrices being decrypted. There are a number of ways in which this may be achieved. The presently preferred method is to hash the data and to include nonce in the key. Nonce is in essence random data obtained from the cryptographic random number generator. The hash can then be encrypted and the encrypted hash is stored on the data matrix or other identifier. The combination of hashing, encryption and the use of a unique identifier which is coupled with a copy stored in a central store ensure that fraud is minimised as attempts to duplicate data matrices will be detected and any documents containing duplicated data matrices will not be honoured. Moreover, as the data is represented in a hashed and encrypted format it is much more difficult for any attempt to be made to reproduce the identifiers.

Other systems that can store layers of information and data sets can also be used, for example, RFID (radio-frequency ID) tags and other secure chips. In each case, the identity object is first generated electronically, and stored until needed. The identity object can be transferred to the RFID tag or secure chip to form a portable object, such as a baggage label or other identifier. In the following description, the use of a data matrix has been described by way of example only.

Such multilevel encryption and storage is ideal for storing identity information, which is itself made up of various levels of information, some of which can only be accessed via a secure environment.

The identity of an individual is comprised of several features, termed identity identification data sets or identity domains. FIG. 13 illustrates the identity domains for an individual. There are three domains: Fixed ID, Variable ID and Government/Security ID. Information from each of these domains can be used to form an identity object, such as a passport, boarding card, baggage label or other article identifier.

Fixed ID includes forms of identification that are physically fixed for a particular individual, for example, date of birth and biometric information such as fingerprints, dental records and DNA. Name is also included, even though this may be changed, as an individual's name is fixed either by themselves or a parent, and not by the state.

Variable ID includes forms of identification that can be used as a secondary proof of identity or residence. For example, an individual's address, utility supplier bills, employer details, marital status, image, PIN and passwords can be used as identification. Time/date and expiry/renewal information can also be seen as Variable ID. All of these forms of identification can, to some extent, be altered by the individual to whom they relate. In particular, even though initially PINs and passwords are allocated by an entity, they are generally user generated.

Government/Security ID includes forms of identification that have been allocated by a government department or authority. Such forms of identification include residence status, immigration status, passport, driving license, National Insurance number and NHS number. These are often forms of identification associated with a permission to carry out an act, for example, to drive or to obtain medical or dental treatment.

Each of these domains represents at least one access level, and some items of information may be found within different access levels, as shown in FIG. 14. Information may be visible or hidden, where hidden data has a higher level of security or confidentiality, and must be verified by the individual being identified. For example, Level 1 access may include the name and address details needed in a retail environment or by a delivery company. Data from two identity domains is therefore accessible by these parties. Such access does not necessarily need to be secure.

Level 2 access requires that access is secure, and may need additional verification from the individual being identified from the hidden data in the data matrix. This includes travel (airline, port or rail travel) details, financial or bank details and Post Office (pensions payments) details. Where additional verification is required, this is normally achieved by means of the individual concerned using PIN number, password or other secure identifier to identify himself to a remote server or authority. At this point, information from both the Fixed ID and Variable ID domains is needed, for example, to confirm a transaction at a bank may require photo ID and a PIN number or password.

Level 3 access also requires verifiable access, with additional, hidden, information in the data matrix being verified by the user. Parties with permission for level 3 access are able to access hidden information and additional records linked to the individual. For example, doctors, hospitals, pharmacies, police or government offices may require access to information such as driving licenses, passports or NHS numbers.

Level 4 access also requires secure access, such as that needed by a government department or agency at a restricted level. For example, passport/immigration border control, police or security services may require that an individual identify themselves based on a combination of name, address, image and passport. Such bodies may require access to confidential records using information stored on the data matrix, or permissions to access information, where the permissions are stored as part of the accessible information in the data matrix.

Where additional user verification is required, the information to be verified may be stored in the data matrix, or a secure access code to access other databases may be stored instead of or as well as the identification information. This is in contrast to the prior art situation, where addition information not stored in the identification document is required from a third party. The access code information may be altered depending on circumstances, but the encoded identity information is locked and secure. In order to verify the data matrix, it may be necessary to pass encoded data back to the party scanning the matrix over a secure connection.

Once the identity domains and access levels have determined the encryption of each identification feature, the encrypted features are stored on the data matrix. The data matrix may be provided in some type of hard copy, such as part of an identification card or passport.

However, once the identity domains and access levels have been decided and encrypted, it is possible to utilise the information in several different ways.

FIG. 14 is a schematic illustration of the use of the identification data matrix to identify, authenticate, verify, track and trace an individual traveler and their luggage at an airport. In this situation, the data matrix is included on an ID card. The generation and use of the data matrix is possible as the individual involved has a unique identity, and the data matrix created will also be unique.

Identification information is stored in the data matrix 201 on the card 202 carried by the airline passenger 203. At the check-in desk 204, the data matrix is scanned using a scanner 205, and used as the basis of a security check to authenticate the identity of the airline passenger 203. Secure and non-secure data are scanned simultaneously; with the secure data being used to initiate a remote authenticate process needing a PIN input by the airline passenger 203. The PIN may be visible to or hidden from the party scanning the data matrix. As identification information is stored in the data matrix with different levels of security and access permissions, it is possible that the information being verified by the PIN or password may be secure or hidden from the local party requesting the PIN/password. The information may be accessed at the check-in terminal for subsequent reading by another party. A local authorised server 206 at the airport 207 is used to authenticate the passenger's 203 details. Also at the check-in desk 204, the data matrix 201 is scanned to retrieve travel data. The travel data is then used to produce a unique personal travel data matrix 208 containing a subset of the data in the original data matrix 201. The travel data matrix 208 is printed onto a baggage label 209, and attached to any luggage 210 being carried by the airline passenger 203. The travel data matrix 208 can be used to identify the luggage 210 and trace it to the airline passenger 203 at any point in the journey. Once the travel data matrix 208 has been attached to the luggage 210, the luggage is scanned out at a second scanner 211 and sent to the aircraft 212.

At the departures passport security desk 213, the data matrix 201 is scanned again to retrieve identification information and passport details. This requires a remote verification step, where a central authority, such as the passport issuer 214, is contacted to verify the information. Information is passed over a secure connection. The verification step may be carried out by a third party 215 holding a database of identity information, where the third party 215 exchanges information with both the security desk 213 and passport issuer 214. Once the identification of the airline passenger 203 has been verified, the passenger enters the departures lounge and boards the aircraft 212.

On landing, the airline passenger's 203 ID card 202 is scanned at the departures desk 218, and the passport and identification information retrieved. Again, where necessary, there is a remote authorisation step, requiring authorisation by the passport issuer 214 via the government 216 of the country the airline passenger 203 is attempting to enter. At this stage, a visa 217 may be applied to the ID card 202. The visa 217 or entry stamp be a third data matrix, containing details of the entry time, date and other relevant information. The visa data matrix may also contain a subset of the information stored in the ID card data matrix 201 and/or travel data matrix 208. Alternatively, the visa may be applied to the identification card 201 before the airline passenger 203 checks in, for example, by an embassy, or at the check-in 204 or departures security 213 desks.

At baggage reclaim 219 the travel data matrix 208 on the baggage label 209 is scanned, to ensure that the luggage 210 is matched to the correct airline passenger 203. If the luggage 210 is missing, the subset of information in the ID card matrix 201 relating to travel can be used to trace the luggage 210.

In the airport situation outlined above, the same data matrix is accessible at different levels by the check-in desk, the security control in the immigration services in the destination country. Information that is not relevant to a particular party, such as passport and visa information for a baggage label check, is not readable by that party. Hence, such information remains secure and confidential.

Where information is used centrally, the data matrix is scanned into a system that is networked or linked in to an online database. The database is interrogated to confirm the identity information or to set of modify parameters, such as access permissions, held on the data matrix. The database may also be interrogated with regard to any records held for the owner of the data matrix. Not only is identification and authentication of information required, but tracking and updating records and disseminating information to other databases or systems regarding the user or data matrix may be involved. It is possible for high level authorities to re-issue a data matrix identity object.

Thus the use of the data matrix enables the verification and authentication of an identity. One advantage of this is that identification of an article enables it to be tracked. In the food industry for example, unique identification objects encoded on data matrices could be applied to all articles and suppliers in a particular food chain. This would result in a product having a data matrix that contained subsets of information from all of the data matrices of articles or suppliers involved in its production process. A tin of baked beans, for example, would have a data matrix with information relating to the box number, delivery date, batch number, product number, production date, production site, supplier name and other information. Then, should a product need to be recalled for any reason, tracing the data matrices containing a subset of information of one of the original data matrices, by searching a database or central store of data matrix information, is straightforward. The addition of a batch or box number to the process history is the last point in the production process where data can be added to the data matrix, and a final data matrix be created and placed on the product. The identity object associated with the article therefore contains identification information and process history information.

A further advantage of generating an identity object to represent the identity of a person is that the need to carry a physical card or to carry a card containing biometric information is removed.

By using the identity domains discussed above, it is possible for a trusted user to generate a data matrix representing an individual's identity from personal information known by the user, and a database of secure information held by a trusted authority. For example, an airline passenger could be identified by name, date of birth and address. This information could be input to an online database at a trusted source, to match with secure information, such as passport details. The individual could then authenticate their identity by use of a PIN number, or other means, such as a password. Once the identity is confirmed, a data matrix containing all the relevant information for the journey, including baggage labels and visa information could be generated at the check-in desk.

FIG. 15 is a schematic diagram of the relationship between the relevant parties necessary to create an identity object, such as a passport.

In order for a body 220, such as at an airport 220a, station 220b, port 220c, border control point 220d or the police 220e to verify or authenticate the identity of an individual 221, an identity object containing information from at least one identity domain 222 is needed. In the situation shown in FIG. 15, a third party 223 is responsible for collating the information and checking it against various records held at the government agency access layer 224. The finished identity object, in this case a document containing a data matrix 225, can be printed at any one of the airport 220a, station 220b, port 220c, border control point 220d, police station 220e, the home of the person 221 requiring the identity object 225 or the third party 223. Where a third party 223 is not used as a central point for collating and authenticating information, a government office or agency 226 can print out the data matrix.

Hence, by using the identity domains discussed above, it is possible for a trusted user to generate a data matrix representing an individual's identity from personal information known by the user, and a database of secure information held by a trusted authority. For example, an airline passenger could be identified by name, date of birth and address. This information could be input to an online database at a trusted source, to match with secure information, such as passport details. The individual could then authenticate their identity by use of a PIN number. Once the identity is confirmed, a data matrix containing all the relevant information for the journey in a secure format, including baggage labels and visa information could be generated at the check-in desk. Once printed, the information encoded in the data matrix cannot be changed.

As an alternative to, or in conjunction with a data matrix, in the case of providing information on a baggage label, an RFID tag could also be encoded containing the electronically generated identity object. The tag would then be fixed or attached to the luggage, enabling identification of the luggage on interrogation of the RFID tag. The identity information can be taken from the data matrix and included on the RFID tag, creating an identity pair.

A second identity object can therefore be generated from a first identity object. This could be by printing out a second copy of an identity object as a duplicate, or by printing a new identity object that is also unique, but contains substantially the same information as, or a subset of the information stored on the original identity object. This enables items and articles to be tied to a person having a unique ID to enable such items and objects to be traced, or enables the printing of other documentation where information relating to the identity of an individual user forms part of that document.

FIG. 16 illustrates the necessary features to allow local printing and checking or the data matrix. These features include a number of separate elements: secure printing module 227, cryptographic function module 228, secure web services 229, data obfuscation module 230, and secure key store 231.

In the situation described above, where a data matrix 201 is printed out as part of the airline check-in process, the secure printing module 227 enables the correct data matrix symbol 201, 208 to be printed as part of a baggage label 209 and boarding pass by the operator at the check-in desk 204. Each data matrix indicia 201, 208 printed out is unique to the airline passenger 203 and is recorded on a central database. Thus, when the baggage is being checked at the arrivals terminal, the data matrix symbol 201, 208 can be scanned and the label 209 authenticated if the same symbol, or data corresponding to that read from the symbol, is found stored in the central database. The secure web services 229 enable secure, on-line checking and verification of the data used to form the data matrix 201. This ensures that the data matrix 201 is genuine and unique. The cryptographic function module 228, data obfuscation module 230 and secure key store 231 are used to provide the encryption necessary to produce the data matrix 201, 208.

The cryptographic functions module 228 is responsible for encryption of the data stored on the data matrix. Thus, the unique information that is printed on data matrix is both stored in a central store and represented as encrypted data using proprietary algorithms to prevent the information printed in the data matrix being decrypted.

The secure key store 231 includes the database referred to above and is the repository for the keys that are issued. Instead of a database, a hardware security module or any other secure storage device could be used. Keys are not placed on the data matrix but are issued to each party to the trusted relationship.

The exact format will depend on the type of encryption used and whether it is symmetric or asymmetric.

The secure key store 231 records those keys that have been used, or where appropriate, partially used. The secure key store can only be accessed through the secure management system and is protected by firewalls and back up systems.

Similarly, the boarding card can be scanned at the departures terminal to check the authenticity of the passenger attempting to board the flight. Once the baggage label or boarding pass has been scanned, the record for that label in the database is flagged. This prevents possible fraud by copying of labels or boarding cards. Thus, the data matrix symbol is used as a convenient way of storing information that can later be read, and compared for verification.

The use of the information stored on the data matrix varies dependent upon individual circumstances. Access levels may be determined by a central database where information regarding the data matrix is kept, or encoded into the data matrix itself, to be read by trusted parties. For example, at a local level, information from the data matrix may be displayed on a screen, for the user to verify, or sent to a database for independent use or verification. Information can also be transferred to a new data matrix, as in the travel data matrix described above, where the new data matrix is a subset of the original, and can also carry encoded access permissions to enable only trusted parties to view relevant levels of information or access codes to enable trusted parties to access remote, secure databases for additional information.

In FIG. 17, the third party 215 is part of a secure network having a secure web server or store 232. Secure communication links are provided between the airport departures security desk 213, the third party and the national government ID authority 214. Rather than a direct access to a secure web-enabled database or central records system, third party 215 holds a library of information. Government agencies upload and maintain certain information, which may be accessed only with appropriate access rights or permissions. It is also possible for the authority to append information onto the record. Such information is contained in the information library. The access rights or permissions are linked to a trusted party and linked keys that are held by the authority scanning the data matrix, and linked to the identification key on the data matrix. The authority accessing this library information is only able to see references to the person about whom information or status is being sought. Access to the information library may be tracked. The use of a key system gives broader access to all files.

A further advantage, as mentioned above, is the ability to produce data matrices containing visa information, to be printed onto a passport or other identity document at an embassy, a border crossing point or other security check. In addition to the information contained in the original identification data matrix, the visa may also contain secure time stamp information. Again, the time stamp information may be encoded using public/private key encryption as described above, to ensure that the visa information when scanned at a border entry point has not been tampered with.

Once an identity object has been generated, the number of times it is printed, and how a second identity object relates to a first, as in the baggage label example above, can either be added as a new layer of information to the identity object or a corresponding record in a central database flagged. The history of a particular identity object can therefore be monitored.

A further advantage of using a data matrix to represent multiple levels of secure identity information is that information regarding the number of permitted uses can be stored either in the data matrix itself, or as part of a corresponding record in a central database.

When an identity object, such as a passport, boarding card or baggage label, is printed out, in order to ensure the security of the object it is necessary to ensure that only the authorised user whose identity is shown on the object is able to use it. For example, if a passport and visa are printed out at a check-in desk for use during that one journey only, or on a return trip, it is necessary to be able to disable the passport and visa once used, to prevent fraud. By using a data matrix to encode both identity information and redemption information, the identity object can be automatically disabled once its designated use has been completed. In other words, the object can be redeemed, and is no longer usable. Alternatively, when the data matrix is scanned, the number of scans can be transmitted to the central database, where the record for that particular data matrix is flagged. The system can be set so that either a single flag or a predetermined number of flags can be set next to a record, to prevent use of the data matrix beyond its designated lifetime or purpose. The expiry of a time dependent identity object, such as a passport, can be handled in the same manner. Expiry information can be encrypted onto the data matrix to be read by an appropriate authority, or the record corresponding to the data matrix at the central database can be flagged to indicate expiry.

It was mentioned above that a second identity object can be generated from a first identity object. This approach of creating a hybrid identity will now be discussed further. A hybrid identity may be created by creating a hybrid VBT. A VBT may first be created, for example when an airline ticket is bought over the Internet or at a travel agent. The ticket will have an associated VBT which may be printed with a data matrix, but need not be so, and will be presented and authenticated at an airport by the check in desk. The check in desk may also require another form of identification such as passport or Identity card, which may also carry a VBT. In its simplest form the Check-in desk will then issue baggage labels for the passenger and those labels will be issued with a second VBT identity that references either or both of the existing VBTs. This reference may be the TIN or other information held in the payload or it may be only be linked in relationship terms by the two databases. Authentication of the first identity creates an element or an optional requirement of the second identity. The linkage between the two may be accessible at other points of presentation to some limited degree, for example the authentication points may be identified even though the specifics of what was identified are not. Within a closed loop system, where a further VBT is issued, the visibility of the authentication points may allow further drilling down to other data specific to those transactions. Of course, a number of related VBTs may be issued at each stage of a complex process such as a passenger taking several flights.

This approach enables different “trusted” parties operating in a particular sphere of business such as travel to authenticate someone else's VBT transaction identity and incorporate it into their own unique VBT issued for a new transaction. It allows each party to generate their own identity linked to their own data sets held on the authentication database, but also pass on the fact that that person (or ticket or baggage) has been processed (seen and authenticated) in a series of transactions, so building a history of the VBT identity. This can bring added levels of confidence and security to a process that currently has little or no tracking capability outside that provided by entering data into a linked computer outside that operated by disparate companies and individuals. When this approach is linked to a PIN held by the person travelling and used to verify each of the transactions and makes it virtually impossible for somebody to intercept that identity as it is always changing but contains a common thread during its lifecycle.

It is common for a single identity to travel unchanged throughout a travel process For example, the name of a passenger does not change. However, what gets lost is any verification or record of authentication done at each point. The use of hybrid VBTs solves that problem. Each issuer retains control of their own data which may be used in various ways as part of their business application, and may be visible to other points in the lifecycle. However, the authentication history links all of the transactions in the lifecycle. If any authentications are missing there would be a possible issue or breach of security. This approach give a high degree of confidence as it would be most difficult to recreate the authentication history as the process preferably changes encryption keys every time the identity is used or presented.

In a closed loop system where a wrapper and/or the core is integrated into a existing track-and-trace solution, this embodiment of the invention enables the creations of a much more secure way to seal authentication transactions as part of end to end visibility than is presently possible. The core and wrapper may be used to provide end-to-end authentication verification across disparate systems linked by the core and wrapper acting as a central authentication service to a trusted party status.

Thus, the hybrid model, with a newly created VBT referring an earlier VBT creates a chain of trust giving accountability of where the VBT identity, and what it is attached to, has been used. Where two or more VBTs have been created, it is possible for both to require authentication in some instances.

Verification does not depend on knowing or being able to read the content. The core server can verify the VBT to the current transaction authentication, passing relevant verification messages and/or VBT status of the VBT information. The audit and reporting function within the core records all transactions relating to the VBT and the wrapper requirements such as redemption. If the subsequent transaction is part of the same loop the wrapper can pass details across to the new iteration of the VBT. If the system doing the authentication transaction is not part of an end-to-end system (loop) then by definition the system has no rights to append any data to the new iteration of the VBT. In this case only a limited amount of data can be passed which may be no more than the fact that it has been authenticated. The core and the wrapper belonging to the 2^{nd} party create a new record and VBT linked to their particular purposes and the fact that the authentication transaction (linked to the first party) has taken place. Under this type of linked transaction process it may be desirable to have central trusted authority which records each and all of the authentications as the VBT passes through its lifecycle.

How much access to other data is granted to each party in the lifecycle of the VBT and its iterations, depends on the level of trust in the group. Where the lifecycle in part or in whole is required, such as may be the case for a security investigation, a central authority may grant access or act as the liaison so the different parties can participate.

The concept of “one shot use” of the VBT creates a very secure token path and is similar to changing the encryption key every time the new iteration is required by the new owner of the system. These transactions are linked by a common system, the core and wrapper even though the connections may not entitle any of the other parties to see confidential data or even reveal the relationship in the path. This solution creates the ability to bind people or items together by using the VBT creating a complex and secure relationship that immediately allows identification of breaks in the chain. Even if someone fraudulently wanted to try and recreate those links it would be virtually impossible because no one person has access to all the parts or even the locations of each transaction.

These authentication points can be regarded as sub nodes. A local server could do batch updates if some basic authentication was required offline, with the system being refreshed on a regular basis. This would enable a closed loop system to continue functioning if real-time connectivity was lost.

Cell phone technology may be used to receive VBTs generated by the core and wrappers. A user may download a VBT to their cell phone whereupon they may store them, and amend them to create new identity object. The VBTs may be received as data strings or a graphic objects such as data matrices.

The example described enables authentication to be linked over a number of disparate systems such as tickets, baggage, visas, and passport stamps with trusted parties passing a common carrier between them for authentication purposes.

Many modifications to the systems and methods described are possible within the scope of the invention and will occur to those skilled in the art. The scope of the invention is limited only by the following claims.

1. A method of generating an identity object electronically, comprising
compiling a first identification data set comprising identification information of a first type and accessible by a first user;
compiling a second identification data set comprising identification information of a second type and accessible by a second user;
encrypting the first and second identification data sets; and
generating the identity object electronically in a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

2. The method of claim 1, comprising transferring the identity object to a portable medium.

3. The method of claim 2, wherein the portable medium is a printed graphical symbol.

4. The method of claim 3, wherein the graphical symbol is a data matrix.

5. The method of claim 2, wherein the portable medium is a cell phone, an RFID tag or a secure chip.

6. A method of creating an identity object, comprising
compiling a first identification data set comprising identification information of a first type and accessible by a first user;
compiling a second identification data set comprising identification information of a second type and accessible by a second user;
encrypting the first and second identification sets; and
creating the identity object by printing a graphical symbol having encoded thereon a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

7. The method of claim 1 or claim 6, wherein the first and second identification data sets are encrypted using different algorithms.

8. The method of claim 1 or claim 6, wherein the first identification data set further comprises identification information of the second type.

9. The method of claim 1 or claim 6, wherein the first user has permission to access both the first identification data set and the second identification data set.

10. The method of claim 1 or claim 6, wherein the first and second identification data sets comprise a unique identifier for the respective identification data set.

11. The method of claim 1 or claim 6, comprising, at the first user:
scanning the identity object to read the first identification data set; and
verifying the identity object by comparing the first identification data set with stored data.

12. The method of claim 11, wherein the step of verifying comprises:
decrypting the first identification data set to retrieve a unique identifier;
comparing the unique identifier with a stored record; and
verifying the identity object if the unique identifier matches the stored record.

13. The method of claim 11, wherein when the first user has permission to access the first identification data set and the second information set, the step of scanning the printed identity object includes the step of reading the second identification data set.

14. The method of claim 13, comprising:
decrypting the second identification data set to retrieve a unique identifier; comparing the unique identifier with a stored record; and
verifying the identity object if the unique identifier matches the stored record.

15. The method of claim 11, wherein the step of verification is performed at a location remote from the location of the step of scanning the item.

16. The method of claim 11, wherein the step of verification is performed by a trusted authority.

17. The method of claim 16, wherein the trusted authority is a secure server or database.

18. The method of claim 11, comprising:
requesting a secure identifier as additional verification of at least one data item in the first identification data set from a holder of the identity object.

19. The method of claim 18, wherein the secure identifier is a PIN number or a password stored separately from the identity object.

20. The method of claim 11, comprising generating a second identity object containing a further identification set and at least some of the same information as the first identity object.

21. The method of claim 20, wherein the second identity object contains secure information that is hidden from the first user.

22. The method of claim 1 or claim 6 wherein the first identification data set comprises data relating to a number of uses of the identity object.

23. The method of claim 1 or claim 6, wherein the data object comprises a further data set encrypted thereon or a reference to a further data set stored at a remote location.

24. The method of claim 23, wherein the further data set comprises data relating to a number of uses of the identity object.

25. The method of claim 1 or claim 6, wherein the identity object cannot be altered once generated.

26. The method of claim 1 or claim 6, wherein the identity object is a passport or an identity card.

27. The method of claim 26, wherein, when the first user prints a second identity object, the second identity object is one of a visa or a baggage label.

28. The method of claim 1 or claim 6, wherein the identity object is applied to an article.

29. The method of claim 28, wherein the identity object comprises information relating to the manufacturer of the article.

30. The method of claim 1, wherein the identity object is compiled from a database of identification data sets and user-provided identification data sets.

31. The method of claim 30, wherein the user provides the first identification data set.

32. The method of claim 1, wherein at least one of the first and second identification data sets is hashed prior to encryption.

33. The method of claim 32, wherein the hash key includes nonce.

34. A method according to claim 1 or claim 6, wherein the data included in the token comprises a reference to the first encrypted data set at a remote location, and wherein that reference to the first data set is encrypted.

35. A method according to claim 1 or claim 6, wherein the data included in the token comprises a reference to the second encrypted data set at a remote location, and wherein that reference to the second data set is encrypted.

36. A method of creating a traceable identity object, comprising
compiling a first identification data set comprising article identification data;
compiling a second identification data set comprising article processing history data;
encrypting the first and second identification data sets; and
generating the identity object by formatting a portable medium including a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

37. The method of claim 36, wherein the portable medium is a printed graphical symbol.

38. The method of claim 37, wherein the graphical symbol is a data matrix.

39. The method of claim 36, wherein the portable medium is an RFID tag or a secure chip.

40. A method of creating a traceable identity object, comprising
compiling a first identification data set comprising article identification data;
compiling a second identification data set comprising article processing history data;
encrypting the first and second identification data sets; and
generating the identity object by formatting a portable medium by encoding thereon a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

41. The method of claim 36 or claim 40, wherein the first and second identification data sets are encrypted using different algorithms.

42. The method of claim 37 wherein the graphical symbol including the first and second identification data sets is printed as a data matrix symbol.

43. The method of claim 36 or 40, comprising generating a second identity object containing substantially the same information as the first identity object.

44. The method of claim 43, wherein the second identity object contains a subset of the information in the first identity object.

45. A system for generating an identity object electronically, comprising
means for compiling a first identification data set comprising identification information of a first type and accessible by a first user;
means for compiling a second identification data set comprising identification information of a second type and accessible by a second user;
means for encrypting the first and second identification data sets; and
means generating the identity object electronically in a secure format including means for creating a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

46. The system of claim 45, comprising means to transfer the identity object to a portable medium.

47. A system for generating an identity object, comprising
means for compiling a first identification data set comprising identification information of a first type and accessible by a first user;
means for compiling a second identification data set comprising identification information of a second type and accessible by a second user;
means for encrypting the first and second identification data sets; and
means for generating the identity object by formatting a portable medium including means for encoding on the portable medium a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

48. The system of claim 47, wherein the portable medium is a printed graphical symbol.

49. The system of claim 48, wherein the graphical symbol is a data matrix.

50. The system of claim 49, wherein the means for generating the identity object by formatting a portable medium is a printer.

51. The system of claim 45 or 47, wherein the portable medium is an RFID tag or a secure chip.

52. The system of claim 45 or 47, comprising means to scan the portable medium and means to read data encoded thereon.

53. The system of claim 52, wherein the means to scan is a scanner.

54. The system of claim 52, comprising means to verify a data set by comparing with stored data.

55. The system of claim 54, comprising means to transmit and receive secure verification data.

56. A system for creating an identity object, comprising
means for compiling a first identification data set comprising identification information of a first type and accessible by a first user;
means for compiling a second identification data set comprising identification information of a second type and accessible by a second user;
means for encrypting the first and second identification sets; and
means for creating the identity object by printing a graphical symbol having encoded thereon a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

57. A system for creating a traceable identity object, comprising
means for compiling a first identification data set comprising article identification data;
means for compiling a second identification data set comprising article processing history data;
means for encrypting the first and second identification sets; and
means for creating the identity object by printing a graphical symbol having encoded thereon a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

58. A system for creating a traceable identity object, comprising
means for compiling a first identification data set comprising article identification data;
means for compiling a second identification data set comprising article processing history data;
means for encrypting the first and second identification sets; and
means for creating the identity object by printing a graphical symbol including encoded thereon a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

59. A system according to claim 45 or 47 or 56 or 57 or 58, wherein the data included in the token comprises a reference to the first encrypted data set at a remote location, and wherein that reference to the first data set is encrypted.

60. A system according to claim 45 or 47 or 56 or 57 or 58, wherein the data included in the token comprises a reference to the second encrypted data set at a remote location, and wherein that reference to the second data set is encrypted.

61. A computer program for generating an identity object electronically, which when run on a computer causes the computer to perform the steps of:
compiling a first identification data set comprising identification information of a first type and accessible by a first user;
compiling a second identification data set comprising identification information of a second type and accessible by a second user;
encrypting the first and second identification data sets; and
generating the identity object electronically in a secure format the identity object comprising a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

62. A computer program for generating an identity object, which when run on a computer causes the computer to perform the steps of:
compiling a first identification data set comprising identification information of a first type and accessible by a first user;
compiling a second identification data set comprising identification information of a second type and accessible by a second user;
encrypting the first and second identification data sets; and
generating the identity object by formatting a portable medium having encoded thereon a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

63. A computer program for creating an identity object, which when run on a computer causes the computer to perform the steps of:
compiling a first identification data set comprising identification information of a first type and accessible by a first user;
compiling a second identification data set comprising identification information of a second type and accessible by a second user;
encrypting the first and second identification sets; and
creating the identity object by printing a graphical symbol having encoded thereon a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

64. A computer program for generating a traceable identity object, which when run on a computer causes the computer to perform the steps of:
compiling a first identification data set comprising article identification data;
compiling a second identification data set comprising article processing history data;
encrypting the first and second identification data sets; and
generating the identity object by formatting a portable medium having encoded thereon a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

65. A computer program for creating a traceable identity object, which when run on a computer causes the computer to perform the steps of:
compiling a first identification data set comprising article identification data;
compiling a second identification data set comprising article processing history data;
encrypting the first and second identification sets; and
creating the identity object by printing a graphical symbol having encoded thereon a value based token having a header, a payload and security portion, the token including data related to the first and second identification data sets and comprising the encrypted first data set or a reference to the first encrypted data set for retrieval of the first data set from a remote location, and the encrypted second data set or a reference to the second encrypted data set for retrieval of the second data set from a remote location.

66. A method of authenticating an identity, comprising generating a first identity object for the identity electronically in a value based token having a header, a payload and security portion, the token including data related to a first identification data set and comprising the first data set in encrypted form or a reference to the first encrypted data set for retrieval of the first data set from a remote location; and
creating a further identity object electronically in a value based token having a header, a payload and security portion, the token including data related to a second identification data set and comprising the second data set in encrypted form or a reference to the second encrypted data set for retrieval of the first data set from a remote location, the second identity object including data linking the second identity object to the first identity object, and an indication that the first identity object has been authenticated.

67. A method of authenticating an identity over a series of related events involving the entity, comprising generating a first identity object for the identity electronically in a value based token having a header, a payload and security portion, the token including data related to a first identification data set and comprising the first data set in encrypted form or a reference to the first encrypted data set for retrieval of the first data set from a remote location; and
creating a further identity object electronically in a value based token having a header, a payload and security portion, the token including data related to a second identification data set and comprising the second data set in encrypted form or a reference to the second encrypted data set for retrieval of the first data set from a remote location, the second identity object including data linking the second identity object to the first identity object.

68. A method according to claim 66 or 67, comprising the step of authenticating the first identity object and creating the further identity object after authentication of the first identity object, the second identity object including an indication that the first identity object has been authenticated.

69. A method according to claim 66 or 67, wherein, after creation of the second identity object, the first and second identity objects both require authentication to authenticate the identity.

70. A method according to claim 66 or 67, wherein after creation of the second identity object, the second identity only requires authentication to authenticate the identity.

71. A method according to claim 66 or 67, comprising creating one or more further identity objects, each further object being created after authentication of the previous identity object and being linked to the previous identity object.

72. A method according to claim 71, wherein each further identity object is linked to all previous identity objects.

73. A method according to claim 66 or 67, comprising authenticating the second and any further identity objects.

74. A method according to claim 73, wherein the first, the second and any further identity objects are authenticated by a common authentication authority.

75. A method according to claim 73, wherein the authentication authority is a central authentication authority remote from the point of presentation of the first or second identity object for authentication.

76. A method according to claim 66 or 67, wherein the first, second and any further identification objects comprise a common carrier passed between trusted authorities.

77. A method according to claim 66 or 67, comprising receiving the first identity object at a cell phone and creating the second and any further identity objects at the cell phone.

78. The method of claim 26, wherein the identity object is compiled from a database of identification data sets and user-provided identification data sets.

79. The method of claim 26, wherein at least one of the first and second identification data sets is hashed prior to encryption.
